(19) United States
(12) Patent Application Publication
(10) Pub. No.: US 2025/0371410 A1
(43) Pub. Date: Dec. 4, 2025

(54) AUTONOMOUSLY-GENERATED, DYNAMIC FEATURE SET FOR A CONTENT GENERATION LEARNING MODEL

(71) Applicant: StatSketch Inc., San Francisco, CA (US)

(72) Inventors: Corne Nagel, Agoura Hills, CA (US); Anthony Chong, San Francisco, CA (US); Samuel Owen, St. Louis, MO (US)

(21) Appl. No.: 18/679,838

(22) Filed: May 31, 2024

(51) Int. Cl. G06N 20/00

(52) U.S. Cl. CPC G06N 20/00

(57) ABSTRACT

An example apparatus, computer-implemented method, and computer program product for autonomously training a content generation framework using an autonomously-generated dynamic framework feature set is provided. An example apparatus may include instructions configured to cause the apparatus to receive a user experience content dataset having target client characteristics related to a plurality of target clients. The apparatus may be further configured to generate exploratory feature sets including target client characteristics, and generate a normalized exploratory feature set score based on one or more content generation objectives. The apparatus further configured to generate a dynamic framework feature set comprised of selected features of the user experience content dataset, and train a content generation learning model based on the dynamic framework feature set to determine content data objects customized for the target clients.

### TECHNOLOGICAL FIELD

Embodiments of the present disclosure generally relate to autonomous feature set generation, and more particularly to autonomously generating and dynamically updating a feature set for a content generation learning model.

### BACKGROUND

Machine learning systems typically utilize features to make determinations about the state of a machine learning environment. Features are individual, measurable characteristics of the machine learning environment and/or characteristics of the target clients interacting with the machine learning environment. Outcomes may be predicted by a machine learning system based on an analysis of the features of the machine learning environment and/or target clients. The quality of predicted outcomes is highly dependent on the features chosen for analysis.

Applicant has identified many technical challenges and difficulties associated with existing machine learning systems. Through applied effort, ingenuity, and innovation, Applicant has solved problems related to machine learning systems by developing solutions embodied in the present disclosure, which are described in detail below.

### BRIEF SUMMARY

Various embodiments are directed to an example apparatus, computer-implemented method, and computer program product for autonomously training a content generation framework using an autonomously-generated dynamic framework feature set. An example apparatus may comprise one or more processors and one or more storage devices storing instructions that are operable, when executed by the one or more processors, to cause the one or more processors to: receive a user experience content dataset comprising target client characteristics related to a plurality of target clients; generate, based at least in part on the user experience content dataset, a plurality of exploratory feature sets each comprising one or more target client characteristics of the user experience content dataset; generate a normalized exploratory feature set score for each exploratory feature set of the plurality of exploratory feature sets, wherein the normalized exploratory feature set score indicates a relative priority of each exploratory feature set relative to the plurality of exploratory feature sets based at least in part on one or more content generation objectives; generate a dynamic framework feature set comprising a plurality of selected features of the user experience content dataset by selecting one or more exploratory set features of the plurality of exploratory feature sets based at least in part on the normalized exploratory feature set scores; generate, using a content generation learning model, a plurality of content data objects comprising a unique content data object customized for each of the plurality of target clients, wherein the content generation learning model is trained based at least in part on the dynamic framework feature set; and transmit a visual representation of the plurality of content data objects to one or more user devices associated with the plurality of target clients.

In some embodiments, the plurality of exploratory feature sets comprises one or more list-based exploratory feature sets and one or more rank-based exploratory feature sets, and the one or more storage devices store instructions that are operable, when executed by the one or more processors, to further cause the one or more processors to: generate, based at least in part on a list-based feature generation model, the one or more list-based exploratory feature sets; and generate, based at least in part on a rank-based feature generation model, the one or more rank-based exploratory feature sets, wherein each exploratory set feature in the one or more rank-based exploratory feature sets is associated with a rank-based feature score.

In some embodiments, the list-based feature generation model comprises a genetic feature selection algorithm.

In some embodiments, the rank-based feature generation model comprises a chi-square feature selection algorithm.

In some embodiments, the one or more storage devices store instructions that are operable, when executed by the one or more processors, to further cause the one or more processors to: generate a plurality of synthetic target features based at least in part on the target client characteristics.

In some embodiments, the dynamic framework feature set comprises an exploratory feature set associated with a highest normalized exploratory feature set score.

In some embodiments, the content generation learning model comprises a supervised learning model and a reinforcement learning model.

In some embodiments, the supervised learning model and the reinforcement learning model are both trained based at least in part on the dynamic framework feature set.

In some embodiments, the one or more storage devices store instructions that are operable, when executed by the one or more processors, to further cause the one or more processors to: receive a feedback user experience content dataset comprising interaction data from a target client based at least in part on the visual representation of the plurality of content data objects presented to the target client on the one or more user devices.

In some embodiments, the one or more storage devices store instructions that are operable, when executed by the one or more processors, to further cause the one or more processors to: determine an updated dynamic framework feature set based at least in part on the feedback user experience content dataset; and retrain the content generation learning model based at least in part on the updated dynamic framework feature set.

In some embodiments, the one or more storage devices store instructions that are operable, when executed by the one or more processors, to further cause the one or more processors to: generate one or more screened exploratory feature sets by selecting a subset of exploratory feature sets of the plurality of exploratory feature sets based at least in part on the normalized exploratory feature set score; and generate the dynamic framework feature set by selecting one or more screened set features from the one or more screened exploratory feature sets.

In some embodiments, selecting one or more exploratory set features of the plurality of exploratory feature sets further comprises determining a correlation of exploratory set features between a subset of the plurality of exploratory feature sets.

In some embodiments, the one or more storage devices store instructions that are operable, when executed by the one or more processors, to further cause the one or more processors to: train a feature selection machine learning model based on the user experience content dataset and the one or more content generation objectives; and determine, using the feature selection machine learning model, one or more selected features from the one or more exploratory set features.

In some embodiments, the one or more storage devices store instructions that are operable, when executed by the one or more processors, to further cause the one or more processors to: generate a plurality of candidate dynamic framework feature sets, each candidate dynamic framework feature set comprising at least one selected feature of the plurality of selected features; generate a candidate dynamic framework feature set score for each candidate dynamic framework feature set in the plurality of candidate dynamic framework feature sets, wherein the candidate dynamic framework feature set score indicates a relative priority of each candidate dynamic framework feature set relative to the plurality of exploratory feature sets based at least in part on the one or more content generation objectives; and assign a candidate dynamic framework feature set from the plurality of candidate dynamic framework feature sets as the dynamic framework feature set based at least in part on the candidate dynamic framework feature set score.

In some embodiments, the one or more content generation objectives comprise a first content generation objective and a second content generation objective, and wherein the one or more storage devices store instructions that are operable, when executed by the one or more processors, to further cause the one or more processors to: generate a first normalized exploratory feature set score for each exploratory feature set of the plurality of exploratory feature sets, wherein the first normalized exploratory feature set score indicates a relative priority of each exploratory feature set relative to the plurality of exploratory feature sets based at least in part on the first content generation objective; generate a second normalized exploratory feature set score for each exploratory feature set of the plurality of exploratory feature sets, wherein the second normalized exploratory feature set score indicates a relative priority of each exploratory feature set relative to the plurality of exploratory feature sets based at least in part on the second content generation objective; generate a first dynamic framework feature set comprising a plurality of selected features of the user experience content dataset by selecting one or more exploratory set features of the plurality of exploratory feature sets based at least in part on the first normalized exploratory feature set scores; and generate a second dynamic framework feature set comprising a plurality of selected features of the user experience content dataset by selecting one or more exploratory set features of the plurality of exploratory feature sets based at least in part on the second normalized exploratory feature set scores.

An example computer-implemented method is also provided. In some embodiments, the example computer-implemented method comprises: receiving a user experience content dataset comprising target client characteristics related to a plurality of target clients; generating, based at least in part on the user experience content dataset, a plurality of exploratory feature sets each comprising one or more target client characteristics of the user experience content dataset; generating a normalized exploratory feature set score for each exploratory feature set of the plurality of exploratory feature sets, wherein the normalized exploratory feature set score indicates a relative priority of each exploratory feature set relative to the plurality of exploratory feature sets based at least in part on one or more content generation objectives; generating a dynamic framework feature set comprising a plurality of selected features of the user experience content dataset by selecting one or more exploratory set features of the plurality of exploratory feature sets based at least in part on the normalized exploratory feature set scores; generating, using a content generation learning model, a plurality of content data objects comprising a unique content data object customized for each of the plurality of target clients, wherein the content generation learning model is trained based at least in part on the dynamic framework feature set; and transmitting a visual representation of the plurality of content data objects to one or more user devices associated with the plurality of target clients.

In some embodiments, the plurality of exploratory feature sets comprises one or more list-based exploratory feature sets and one or more rank-based exploratory feature sets, the computer-implemented method further comprising: generating, based at least in part on a list-based feature generation model, the one or more list-based exploratory feature sets; and generating, based at least in part on a rank-based feature generation model, the one or more rank-based exploratory feature sets, wherein each exploratory set feature in the one or more rank-based exploratory feature sets is associated with a rank-based feature score.

In some embodiments, the list-based feature generation model comprises a genetic feature selection algorithm.

In some embodiments, the rank-based feature generation model comprises a chi-square feature selection algorithm.

In some embodiments, the example computer-implemented method further comprises: generating a plurality of synthetic target features based at least in part on the target client characteristics.

In some embodiments, the content generation learning model comprises a supervised learning model and a reinforcement learning model.

In some embodiments, the supervised learning model and the reinforcement learning model are both trained based at least in part on the dynamic framework feature set.

In some embodiments, the example computer-implemented method further comprises: receiving a feedback user experience content dataset comprising interaction data from a target client based at least in part on the visual representation of the plurality of content data objects presented to the target client on the one or more user devices; determining an updated dynamic framework feature set based at least in part on the feedback user experience content dataset; and retraining the content generation learning model based at least in part on the updated dynamic framework feature set.

An example computer program product for determining a dynamic framework feature set for a learning framework is further provided. In some embodiments, the example computer program product may comprise at least one non-transitory computer-readable storage medium having computer-readable program code portions stored therein, the computer-readable program code portions comprising an executable portion configured to: receive a user experience content dataset comprising target client characteristics related to a plurality of target clients; generate, based at least in part on the user experience content dataset, a plurality of exploratory feature sets each comprising one or more target client characteristics of the user experience content dataset; generate a normalized exploratory feature set score for each exploratory feature set of the plurality of exploratory feature sets, wherein the normalized exploratory feature set score indicates a relative priority of each exploratory feature set relative to the plurality of exploratory feature sets based at least in part on one or more content generation objectives; generate a dynamic framework feature set comprising a plurality of selected features of the user experience content dataset by selecting one or more exploratory set features of the plurality of exploratory feature sets based at least in part on the normalized exploratory feature set scores; generate, using a content generation learning model, a plurality of content data objects comprising a unique content data object customized for each of the plurality of target clients, wherein the content generation learning model is trained based at least in part on the dynamic framework feature set; and transmit a visual representation of the plurality of content data objects to one or more user devices associated with the plurality of target clients.

In some embodiments, the plurality of exploratory feature sets comprises one or more list-based exploratory feature sets and one or more rank-based exploratory feature sets, the executable portion of the computer program product further configured to: generate, based at least in part on a list-based feature generation model, the one or more list-based exploratory feature sets; and generate, based at least in part on a rank-based feature generation model, the one or more rank-based exploratory feature sets, wherein each exploratory set feature in the one or more rank-based exploratory feature sets is associated with a rank-based feature score.

Various other embodiments are also described in the following detailed description and in the attached claims.

### BRIEF DESCRIPTION OF THE DRAWINGS

Reference will now be made to the accompanying drawings. The components illustrated in the figures may or may not be present in certain embodiments described herein. Some embodiments may include fewer (or more) components than those shown in the figures in accordance with an example embodiment of the present disclosure.

FIG. 1 illustrates a block diagram of an example fin comprising a content generation framework in accordance with an example embodiment of the present disclosure.

FIG. 2 illustrates a block diagram of an example apparatus that can be specially configured in accordance with an example embodiment of the present disclosure.

FIG. 3 illustrates a block diagram of an example content generation framework within an autonomous content generation system in accordance with an example embodiment of the present disclosure.

FIG. 4 illustrates a block diagram of an example autonomous feature selection model in accordance with an example embodiment of the present disclosure.

FIG. 5A depicts an example flow diagram illustrating dynamic framework feature set generation in accordance with an example embodiment of the present disclosure.

FIG. 5B depicts an example flow diagram utilizing candidate dynamic framework feature sets in generating a dynamic framework feature set in accordance with an example embodiment of the present disclosure.

FIG. 6 illustrates a block diagram of an example content generation framework including an autonomous feature selection model and a content generation learning model in accordance with an example embodiment of the present disclosure.

FIG. 7 illustrates a block diagram of an example content generation framework including a feature selection machine learning model in accordance with an example embodiment of the present disclosure.

FIG. 8 depicts an example flow diagram illustrating dynamic framework feature set generation in accordance with an example embodiment of the present disclosure.

FIG. 9A-9B illustrate a process depicting example operations for autonomously generating a dynamic framework feature set in accordance with an example embodiment of the present disclosure.

### DETAILED DESCRIPTION

Embodiments of the present disclosure now will be described more fully hereinafter with reference to the accompanying drawings, in which some, but not all, embodiments of the disclosure are shown. Indeed, embodiments of the disclosure can be embodied in many different forms and should not be construed as limited to the embodiments set forth herein, rather, these embodiments are provided so that this disclosure will satisfy applicable legal requirements. Like numbers refer to like elements throughout.

### Overview

Various example embodiments address technical problems associated with determining feature sets to train and classify machine learning models in an automated content generation framework. As will be appreciated, there are numerous example scenarios in which a machine learning model in an automated content generation framework may benefit from autonomous determination of feature sets.

Machine learning models utilize computer-implemented algorithms to uncover hidden (or apparent) insights through machine-based learning, based on historical relationships and trends in a dataset. Machine learning models may generate reliable, repeatable predictions and results based on features extracted from the dataset. Various machine learning models may be implemented depending on the type of available data, the desired output, the computing environment, and other factors. For example, a machine learning model may comprise a supervised learning machine learning model, an unsupervised machine learning model, a reinforcement learning machine learning model, or any combination thereof.

Utilization of a machine learning model in a machine learning environment may require two stages, a machine learning training process and a machine learning prediction process. Example machine learning prediction processes may include classification and/or regression processes. During the machine learning training process, a machine learning model is trained based on features extracted from a training dataset. In some embodiments, the machine learning model may utilize supervised learning with the training dataset and observed outcomes, and in other embodiments, the machine learning model may utilize unsupervised learning (e.g., clustering) with the training dataset. The machine learning training process adjusts parameters of the machine learning model based on the features extracted from the training dataset to generate predictions. During the machine learning prediction process, classifications or predictions are made using the trained machine learning model and features extracted from a machine learning environment dataset. The machine learning environment dataset may include features related to the state of the machine learning environment in which the machine learning model is operating. Commonly, the features extracted from the training dataset during the machine learning training process are the same as the features extracted from the machine learning environment dataset during the machine learning prediction process.

Features are individual, measurable characteristics of the machine learning environment, including characteristics of target clients interacting within the machine learning environment and with the machine learning model. The machine learning model generates one or more predictions based on the set of features extracted from the machine learning environment dataset. The accuracy of the predictions generated by the machine learning model may be highly dependent upon the set of features extracted from the training dataset during the machine learning training process and the machine learning environment dataset during the subsequent machine learning prediction process.

Selection of features for training and classification in a machine learning environment is often computationally time-consuming, resource intensive, and/or prone to errors and inefficiencies. For example, a training and/or machine learning environment dataset may include a vast amount of data, complex data associated with high-dimensionality, and/or data from disparate data sources. Such datasets are often necessary for training accurate machine learning models and providing accurate predictions during the machine learning prediction process.

In some examples, the feature set used for training and classification of a machine learning model may require feature engineering, involving manual intervention by a sophisticated user. Extraction of features from a dataset may be facilitated by users interacting with computing systems in order to transform a dataset into a particular feature set for a machine learning model, taking into account certain objectives of the machine learning model. Features may be selected for inclusion based on the availability of data, any apparent correlation of the feature with one or more objectives of the machine learning model, or other similar factors. Manual selection of the set of features may require significant time and resources and may require extensive knowledge of the machine learning model and objectives. Even then, manual selection of the set of features may lead to a poorly trained machine learning model and inaccurate and/or unreliable classifications based on the machine learning model.

Additionally, the number of features selected for extraction may have an impact on the overall performance of a machine learning model. The number of features extracted from a dataset may result in data loss with respect to the dataset, overfitting or underfitting of the features for a particular machine learning task, and/or irrelevant features for a particular machine learning task. Too many features may impact the computational performance of a machine learning model while too few features may lead to inaccurate results. As such, machine learning systems often suffer from performance and accuracy deficiencies due to the selection of features for training during the machine learning training phase of the machine learning system and corresponding features used for classification during the machine learning prediction process.

The various example embodiments described herein utilize various techniques to autonomously generate a dynamic framework feature set from a user experience content dataset comprising a plurality of target client characteristics. The dynamic framework feature set may be used to autonomously train a content generation learning model of a content generation framework configured to generate content data objects for target clients. For example, a content generation framework within an autonomous content generation system may leverage an autonomous feature selection model to autonomously select a dynamic framework feature set to train one or more machine learning models comprising the content generation framework, during the machine learning training process, and provide content data objects to target clients based on classifications and predictions of the one or more machine learning models, during the machine learning classification phase.

Embodiments of the autonomous feature selection model disclosed herein may use a multi-validation process for generating a dynamic framework feature set for use in one or more downstream computing processes (e.g., machine learning model(s)). In some embodiments, the multi-validation process may include scoring exploratory features and/or feature sets and then assembling and scoring a plurality of candidate dynamic framework feature sets to identify the optimal combination of features for the objectives of the downstream machine learning process(es).

In some embodiments, the autonomous feature selection model may be performed repeatedly for each iteration (or a set of iterations) of a reinforcement learning model. In some embodiments, the autonomous feature selection model may be used for data with a high lag (e.g., multiple months, one year, or multiple years between deployment of a model output and receipt of the resultant state. In such embodiments, the present autonomous feature selection model may improve the model training and execution, such as by more efficiently and more accurately training the downstream machine learning models.

As a result of the herein described example embodiments, the accuracy and reliability of a machine learning model configured to generate custom content data objects for a target client may be greatly improved. By autonomously generating a dynamic framework feature set using an autonomous feature selection model, a content generation learning model utilizing one or more machine learning models may generate more accurate predictions in support of the generation of content data objects for target clients. These predictions may elicit desired responsive actions from the target clients intended to receive the content data objects.

In addition, utilizing an autonomous feature selection model to determine a dynamic framework feature set may utilize less resources. By accurately determining the optimal number of features necessary to provide the desired output, in some instances, the number of features utilized by a content generation framework may be greatly reduced, particularly in an instance in which a vast feature set is traditionally used regardless of the declining return of additional features. Fewer features in a dynamic framework feature set may require less processing power, compute resources, and time when utilized by the one or more machine learning models comprising the content generation learning model.

Leveraging an autonomous feature selection model may enable rapid content generation with less iterations. Rapid content generation ensures content data objects are presented to target clients based on recent machine learning environment data. Generation of content data objects based on recent machine learning environment data is especially important in an environment in which the environment data is consistently changing and/or in an environment in which the time between iterations may be long.

For example, in some embodiments, massive amounts of data relative to a target client may be available to a content generation framework. Often, a sophisticated user with knowledge of the content generation framework, the content generation learning model, the target clients, and/or the machine learning environment may be necessary to determine features that will produce accurate results. Manual involvement may lead to delays in the generation of content data objects based on recent machine learning environment data. An autonomous feature selection model may eliminate or drastically reduce the need for manual involvement resulting in generated content data objects based on recent machine learning environment data. In addition, reduction in manual involvement may reduce errors introduced into the content generation learning model based on user error or lack of user knowledge with regard to the selection of features. Further, the autonomous selection of features using an autonomous feature selection model may increase the stability of the content generation framework and its underlying machine learning model(s) and process(s). For example, the autonomous selection of features may stabilize the results generated by the content generation framework, improving the experience of a vendor utilizing the content generation framework. Autonomous feature selection may also stabilize the sets of features comprising the dynamic framework feature set utilized by the content generation framework, enabling a vendor to identify and capture the most relevant features of a target client. Both the machine learning models discussed herein, and the performance of the underlying computing hardware may be improved by the efficiencies and accuracy improvements facilitated by the embodiments of the present disclosure.

Autonomously generating and periodically updating the dynamic framework feature set may further ensure predictive outcomes of a content generation learning model are based on recent machine learning environment data. Content data objects based on recent machine learning environment data are more likely to elicit the desired responsive actions from the intended target clients. In addition, rapid return based on recent machine learning environment data may enable deployment of a content generation framework in a reduced time frame. Utilizing a synthetic feature generation model to generate additional synthetic target features may further enable rapid improvements in predictive outcomes, particularly in a data-constrained environment.

### Example Terminology

The term “autonomous content generation system” refers to computing devices, interfaces, interconnects, and other electrical components configured to support interactions between one or more computing devices, a content generation framework, a network, and a plurality of target client devices. Example electrical components may include a terminal for the input of a user experience content dataset and content generation objectives to the content generation framework. The content generation framework generates renderable content data objects that are transmitted via a network to target clients. The content generation framework receives interaction data from the target clients based on responsive actions recorded by the target clients.

The term “content generation framework” refers to one or more computing devices or system of computing devices configured to generate renderable content data objects to be provided to a target client. The content generation framework receives interaction data indicative of a responsive action taken by the target client in response to the provided renderable data object. A content generation framework comprises a content generation learning model having one or more machine learning models configured to autonomously determine custom, renderable data objects for a target client, to maximize one or more content generation objectives. The content generation framework is configured to train the one or more machine learning models comprising the content generation learning model and predict outcomes based on a dynamic framework feature set generated by an autonomous feature selection model. During initialization and throughout operation, the content generation framework may accept user experience content datasets to redetermine a dynamic framework feature set and/or refine various parameters and hyperparameters comprising the one or more machine learning models of the content generation learning model. A non-limiting example of a content generation framework may include a web service operated by a vendor and configured to generate and distribute custom promotions to existing and perspective customers.

The term “autonomous feature selection model” refers to one or more computing devices or systems of computing devices configured to determine a dynamic framework feature set from a user experience content dataset based on content generation objectives. An autonomous feature selection model determines the features and/or number of features utilized by the content generation learning model such that optimal renderable content data objects are selected for a particular target client based on the user experience content data set and the content generation objectives. The autonomous feature selection model generates an initial dynamic framework feature set based on an initial user experience content dataset. In addition, the autonomous feature selection model regenerates updated dynamic framework feature sets periodically based on feedback user experience content datasets.

The term “user experience content dataset” refers to one or more data structures mapping one or more features or characteristics of the learning model state, including target client characteristics, and one or more associated responsive actions performed by the target client. An initial user experience content dataset may include features or characteristics of the learning model state and associated responsive actions over a historical period. Feedback user experience content datasets are periodically generated by the content generation learning model based on the learning model state and associated responsive actions performed by the target client during operation of the content generation learning model. A non-limiting example of a user experience content dataset may include a database including historical customer data, such as customer demographic data, interests, spending habits, and redeemed promotions.

The term “content generation objectives” refers to one or more data structures including parameters by which responsive action taken by a target client may be quantified. Content generation objectives may include limitations related to content data objects, for example characteristic ranges limiting the possible values for variable interactive action characteristics and/or characteristic step limitations related to the change in variable interactive action characteristics over a period of time. Example content generation objectives of an example vendor may include maximizing return on investment, minimizing customer churn, increasing checkouts on viewed content data objects, increasing speed of checkouts, and so on.

The term “characteristic range” refers to a range of authorized values for one or more variable interactive action characteristics of a content data object. Characteristic ranges may be authorized by one or more content generation objectives.

The term “characteristic step limitation” refers to a maximum step size for one or more variable interactive action characteristics over a defined period. For example, a content generation objective may indicate that a voucher amount is to have a maximum step size of 10% per iteration. Thus, the voucher amount may move up or down only 10% for each iteration of renderable content data object presented to the target client.

The term “content data objects” refers to one or more data constructs including data content, generated by a content generation framework and intended to induce a responsive action from a particular target client. In one or more embodiments, example data content may include a message, a status update, an offer, an instruction set, or similar content. A content data object may include a mode of data content delivery (e.g., transmission via one or more communication protocols and/or routes, such as triggering a short message service message, email, or other transmission over one or more selected networks). In some embodiments, a content data object may be embodied as a renderable content data object including a visual display to be presented to a target client and configured to induce a responsive action.

The term “target client” refers to one or more computing devices, machines, services, applications, or other entity for which a content generation framework is configured to generate renderable content data objects. A target client may be associated with a user identifier, which may be one or more items of data by which a user may be uniquely identified. A target client exhibits target client characteristics. Target client characteristics include one or more quantifiable characteristics relating to the state of the target client and/or the associated user. The target client characteristics associated with the target client may be recorded and transmitted as part of the learning model state at the content generation learning model. Target clients and/or users associated with the target clients are configured to produce one or more responsive actions in response to the receipt of a content data object.

The term “target client characteristic” refers to one or more quantifiable attributes of a target client, the environment of the target client, or any other quantifiable attribute of the autonomous content generation system as it relates to a target client. Target client characteristics are provided to a content generation framework as part of a user experience content dataset. Non-limiting examples of target client characteristics may include demographic data related to the consumer, such as, age, income, employment status, education, ethnicity, occupation, gender, marital status, political affiliation, geographic location, family makeup, nationality, interests, living status, and so on.

The term “responsive action” refers to one or more data signals transmitted by a target client representing an action taken by the target client, and/or a user associated with the target client, in response to receiving a content data object. A responsive action may include the transmission of one or more data packets and/or other electronic interaction performed by the target client in response to receiving the content data object. In some embodiments, a responsive action may be performed by a user associated with a target client. For example, a user associated with a target client may view, click on, hover over, or otherwise interact with a renderable content data object.

The term “interaction data” refers to one or more data objects or sets of data objects indicating characteristics related to a responsive action executed by a target client. In addition to indicating the type of responsive action performed, interaction data may include further characteristics of the responsive action such as the duration of the responsive action, the input method of the responsive action, the electronic device type used to interact with the renderable content data object, and so on. In a non-limiting example, interaction data may include a data packet identifying a target client, the renderable content data object transmitted (e.g., promotion details) to the target client, and the responsive action (e.g., redeemed the promotion) taken by the target client.

The term “dynamic framework feature set” refers to one or more sets of one or more features related to a user experience content dataset and determined by the autonomous feature selection model as indicative, individually or in conjunction with other features, of one or more content generation objectives. A dynamic framework feature set is periodically updated based on one or more feedback user experience content datasets. The dynamic framework feature set may comprise synthetic target features generated by one or more synthetic feature generation models. Comparisons to historical dynamic framework feature sets and tests against historical user experience content datasets may be utilized to ensure the performance of a dynamic framework feature set is improved over time. In a non-limiting example, a dynamic framework feature set may include a list of feature labels (e.g., target client age, target client income, target client duration of relationship, etc.). In some embodiments, multiple dynamic framework feature sets (e.g., “candidate dynamic framework feature sets”) may be generated and scored to identify an optimal or otherwise selected dynamic framework feature set.

The term “synthetic feature generation model” refers to one or more processes, mechanisms, algorithms, etc. implemented in hardware and/or software for generating a set of one or more synthetic target features based on the target client characteristics included in a user experience content dataset. Synthetic features may be generated by a synthetic feature generation model to artificially expand the user experience content dataset. By artificially enhancing the user experience content dataset, relations between target client characteristics and predicted outcomes may be discovered. A non-limiting example synthetic feature may be the monthly income of the target client multiplied by the age of the target client.

The term “feature set ensemble generation model” refers to one or more processes, mechanisms, algorithms, etc. implemented in hardware and/or software for generating one or more exploratory feature sets comprising exploratory set features based on a set of features, such as an expanded user experience content dataset, a user experience content dataset, or other similar feature set. A feature set ensemble generation model is configured to utilize a list-based feature generation model and/or a rank-based feature generation model to generate one or more exploratory feature sets comprising the exploratory feature sets. The autonomous feature selection model selects one or more exploratory set features based at least in part on a normalized exploratory feature set score for inclusion in the dynamic framework feature set.

The term “expanded user experience content dataset” refers to one or more sets of features comprising one or more features derived from the user experience content dataset using a synthetic feature generation model. In some embodiments, the expanded user experience content dataset may include all of the features of the user experience content dataset plus the synthetic features generated by the synthetic feature generation model.

The term “plurality of exploratory feature sets” refers to one or more groups or collections of feature sets generated by one or more feature generation models of the feature set ensemble generation model and comprising at least a list-based exploratory feature set and a rank-based exploratory feature set.

The term “list-based feature generation model” refers to one or more processes, algorithms, or other similar mechanisms configured to generate a subset of features (e.g., exploratory set features) from the collection of features available to the feature set ensemble generation model such that the likelihood of one or more content generation objectives is maximized. For example, a list-based feature generation model may determine combinations of features selected from the collection of features that uncover hidden insights and trends in a dataset. A non-limiting example of a list-based feature generation model may include a genetic feature selection algorithm.

The term “rank-based feature generation model” refers to one or more processes, algorithms, or other similar mechanisms configured to generate a ranking or priority of features (e.g., exploratory set features) from the collection of features available to the feature set ensemble generation model such that a high rank or priority corresponds to a feature highly correlated with one or more content generation objectives. A non-limiting example of a list-based feature generation model may include a chi-square feature selection algorithm.

The term “exploratory feature set validation model” refers to one or more processes, mechanisms, algorithms, etc. implemented in hardware and/or software for generating a normalized exploratory feature set score for each exploratory feature set generated by the feature set ensemble generation model. The normalized exploratory feature set score provides a mode for comparing exploratory feature sets even in an instance in which the exploratory feature sets were generated by differing mechanisms.

The term “screened exploratory feature sets” refers to one or more exploratory feature sets selected based on the normalized exploratory feature set score. An exploratory feature set validation model may use one or more processes, methods, or mechanisms to select the exploratory feature sets to be included in the screened exploratory feature sets. In a non-limiting example, an exploratory feature set validation model may select the exploratory feature sets associated with the highest normalized exploratory feature set score.

The term “feature extraction” refers to one or more processes, mechanisms, or algorithms for determining quantifiable characteristics (e.g., target client characteristics) from a user experience content dataset. Feature extraction may include accessing data from a labeled or unlabeled data structure. Feature extraction may include various mathematical determinations based on one or more quantifiable characteristics included in a user experience content dataset.

The term “feature extraction model” refers to circuitry including hardware and/or software configured to select one or more features from the plurality of exploratory feature sets for inclusion in the dynamic framework feature set, based at least in part on the normalized exploratory feature set score associated with each of the exploratory feature sets. A feature extraction model may utilize one or more processes, algorithms, or other mechanisms for selecting features for inclusion in the dynamic framework feature set.

The term “content generation model” refers to one or more trained machine learning models configured to generate content data objects based on the candidate content data objects, one or more content generation objectives, and the content generation learning model state of a target client. Content data objects may be determined based on predicted content data object ranks, content data object scores, confidence values, or other metrics associated with one or more content data objects of the set of candidate content data objects. The content data object metrics may be determined by a trained machine learning model, for example a reinforcement learning model, comprising the content generation model.

The term “content generation learning model state” refers to one or more data constructs representing the current state of the target client for which a content data object may be provided. The content generation learning model state includes interaction data in response content data objects previously provided to the target client, feedback user experience content datasets, and other target client characteristics. A current content generation learning model state refers to a content generation learning model state including recent data related to the associated target client and recent responsive actions performed by a target action in relation to one or more renderable content data objects.

The term “supervised learning model” refers to one or more trained machine learning models based on traditional supervised learning techniques and configured to generate a plurality of candidate content data objects based on the content generation learning model state. A supervised learning model may include a decision space generation model. A decision space generation model refers to one or more trained machine learning models configured to generate the plurality of candidate content data objects based on the particular target client and in compliance with one or more characteristic ranges and characteristic step limitations based at least in part on the content generation objectives. The plurality of candidate content data objects may be generated to be distributed throughout the decision space of possible content data objects. For example, a content data object may include one or more variable interactive action characteristics. The variable interactive action characteristics may be subject to a characteristic range. The decision space may include the full breadth of possible combinations of variable interactive action characteristics of a content data object for the target client. The decision space generation model may vary the content data objects comprising the candidate content data objects to be distributed within the decision space for the target client.

The terms “supervised model” and “predictive model” refer to a supervised model, which is an estimate of a mathematical relationship in which the value of a dependent variable is calculated from the values of one or more independent variables. The functional form of the relationship is determined by the specific type (e.g., decision tree, Generalized Linear Model, gradient boosted trees) of supervised model. Individual numeric components of the mathematical relationship are estimated based on a set of training data. The set of functional forms and numerical estimates a specific type of supervised model can represent is called its “hypothesis space”.

The term “feature vector” refers to an n-dimensional vector of features that represent an object, such as a target client. N is a number. Many algorithms in machine learning require a numerical representation of objects, and therefore the features of the feature vector may be numerical representations.

The term “environment interface” refers to hardware, software, and/or a combination thereof configured to transmit renderable content data objects and receive interaction data via a network. The environment interface may be configured to compile the interaction data with historical data and other characteristics of the target client to generate a content generation learning model state. Non-limiting examples may include an application programming interface (API) facilitating communication between the content generation framework and one or more target clients; file transfer protocol configured to facilitate the transfer of one or more files between the content generation framework and one or more clients; mutual access to a database; and so on.

The terms “trained machine learning model,” “machine learning model,” “model,” or “one or more models” refer to a machine learning or deep learning task or mechanism. Machine learning is a method used to devise complex models and algorithms that lend themselves to prediction. A machine learning model is a computer-implemented algorithm that may learn from data with or without relying on rules-based programming. These models enable reliable, repeatable decisions and results and uncovering of hidden insights through machine-based learning from historical relationships and trends in the data. In some embodiments, the machine learning model is a clustering model, a regression model, a neural network, a random forest, a decision tree model, a classification model, or the like.

A machine learning model is initially fit or trained on a training dataset (e.g., a set of examples used to fit the parameters of the model). The model may be trained on the training dataset using supervised learning or unsupervised learning. The model is run with the training dataset and produces a result, which is then compared with a target, for each input feature vector in the training dataset. Based on the result of the comparison and the specific learning algorithm being used, the parameters of the model are adjusted. The model fitting may include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g., the number of hidden units in a neural network).

A machine learning model may be trained in a machine learning training process previous to deployment and/or trained in real-time (e.g., online training) while in use. For example, a machine learning model may be trained based on reinforcement learning. A reinforcement learning model may receive rewards or penalties based on actions taken or predictions. Reinforcement learning is based on generating high reward values for desired outcomes and low or no reward values for undesired ones. A reinforcement learning model is configured over time to perform actions that lead to maximum reward. A reinforcement learning model includes an agent configured to take actions, receive rewards based on the actions, and update the machine learning model to maximize the received reward.

A system may train different ML models for different needs and different ML-based engines. The system may generate new models (based on the gathered training data) and may evaluate their performance against the existing models. Training data may include any of the gathered information, as well as information on actions performed based on the various recommendations.

The ML models may be any suitable model for the task or activity implemented by each ML-based engine. Machine learning models are known in the art and are typically some form of neural network. The term refers to the ability of systems to recognize patterns on the basis of existing algorithms and data sets to provide solution concepts. The more they are trained, the greater knowledge they develop.

The underlying ML models may be learning models (supervised or unsupervised).

As examples, such algorithms may be prediction (e.g., linear regression) algorithms, classification (e.g., decision trees, k-nearest neighbors) algorithms, time-series forecasting (e.g., regression-based) algorithms, association algorithms, clustering algorithms (e.g., K-means clustering, Gaussian mixture models, DBscan), or Bayesian methods (e.g., Naïve Bayes, Bayesian model averaging, Bayesian adaptive trials), image to image models (e.g., FCN, PSPNet, U-Net) sequence to sequence models (e.g., RNNs, LSTMs, BERT, Autoencoders) or Generative models (e.g., GANs).

Alternatively, ML models may implement statistical algorithms, such as dimensionality reduction, hypothesis testing, one-way analysis of variance (ANOVA) testing, principal component analysis, conjoint analysis, neural networks, support vector machines, decision trees (including random forest methods), ensemble methods, and other techniques. Other ML models may be generative models (such as Generative Adversarial Networks or auto-encoders) to generate definitions and elements.

In various embodiments, the ML models may undergo a training or learning phase before they are released into a production, runtime, or classification phase or may begin operation with models from existing systems or models. During a training or learning phase, the ML models may be tuned to focus on specific variables, to reduce error margins, or to otherwise optimize their performance. The ML models may initially receive input from a wide variety of data, such as the gathered data described herein.

The terms “classifier algorithm” or “classification algorithm” refer to a classifier algorithm which estimates a classification model from a set of training data. The classifier algorithm uses one or more classifiers and an associated algorithm to determine a probability or likelihood that a set of data belong to another set of data. A decision tree model where a target variable can take a discrete set of values is called a classification tree (i.e., and therefore can be considered a classifier or classification algorithm).

The terms “data,” “content,” “digital content,” “digital content object,” “signal,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be transmitted directly to another computing device or may be transmitted indirectly via one or more intermediary computing devices, such as, for example, one or more servers, relays, routers, network access points, base stations, hosts, and/or the like.

### Example System

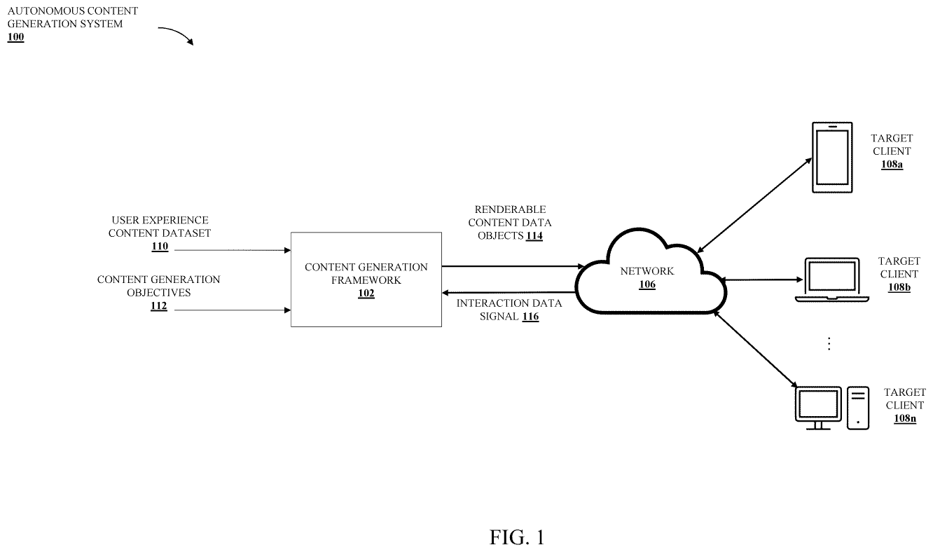

Referring now to FIG. 1, a block diagram of an example autonomous content generation system 100 is provided. As depicted in FIG. 1, the example autonomous content generation system 100 includes a content generation framework 102 configured to send renderable content data objects 114 to one or more target clients 108a-108n, via a network 106, and receive interaction data signals 116 from the one or more target clients 108a-108n via the network 106. The content generation framework 102 is further configured to receive a user experience content dataset 110 and content generation objectives 112.

As depicted in FIG. 1, the example autonomous content generation system 100 includes a content generation framework 102. The content generation framework 102 refers to one or more computing devices configured to support one or more autonomous feature selection models for generating a dynamic framework feature set and one or more machine learning models for providing renderable content data objects 114 to a target client 108a-108n. A content generation framework 102 is configured to determine a custom renderable content data object 114 specifically selected for a target client 108a-108n based on one or more desired outcomes provided at least in part by the content generation objectives 112. A content generation framework 102 may utilize the one or more machine learning models to determine the success of a renderable content data object 114 based on the interaction data signals 116 returned by the target client 108a-108n.

As further depicted in FIG. 1, the content generation framework 102 is configured to interact with one or more target clients 108a-108n. The content generation framework 102 is configured to generate one or more renderable content data objects 114 based on one or more target client characteristics of the target client 108a-108n and/or associated user. In some embodiments, a target client 108a-108n may be associated with a user by a user identifier. In addition, in some embodiments, a target client 108a-108n may be associated with one or more user devices. For example, a target client 108a-108n may be associated with a customer or potential customer of a vendor operating the content generation framework 102. Customers may include businesses, consumers, or other entities. In such an embodiment, target client characteristics may include characteristics of the user associated with the target client 108a-108n. Such target client characteristics may include demographic data related to the consumer, such as, age, income, employment status, education, ethnicity, occupation, gender, marital status, political affiliation, geographic location, family makeup, nationality, interests, living status, and so on.

In addition, target client characteristics associated with a target client 108a-108n may include certain characteristics related to the status of the user associated with the target client 108a-108n in relation to the vendor operating the content generation framework 102. For example, a user associated with a target client 108a-108n may be classified as a potential customer, new customer, existing customer, or dormant customer. In some embodiments, the content generation framework 102 may be configured to determine the relationship of the user associated with the target client 108a-108n to the vendor based on the characteristics of the target client 108a-108n. For example, a user associated with a target client 108a-108n may be classified as a potential customer, new customer, existing customer, or dormant customer based on the duration of the relationship of the user with the vendor. In addition, a user associated with a target client 108a-108n may be classified as a potential customer, new customer, existing customer, or dormant customer based on the number or type of interactions between the vendor and the user.

Based on the characteristics of the users associated with the target clients 108a-108n certain risks and/or opportunities may be associated with each user. A risk of a user may include any interaction between the vendor and the target client 108a-108n exhibiting a negative outcome for the vendor. For example, risks may include churn, meaning the user associated with the target client 108a-108n ceases interactions with the vendor. In some instances, the user associated with the target client 108a-108n may cease making purchases from the vendor.

Certain opportunities may also be available to a vendor based on the characteristics of a user associated with a target client 108a-108n. For example, a vendor may have an opportunity to increase interaction volumes with a target client 108a-108n (e.g., increased sales volume). In addition, a vendor may increase the types of interaction with a target client 108a-108n. For example, a vendor may provide additional products or services that a target client 108a-108n may utilize (e.g., cross sell).

In some embodiments, the status of the target client 108a-108n may be determined by a content generation framework 102 based on the received interaction data signals 116 in conjunction with characteristics of the target client 108a-108n. In addition, the likelihood of certain risks and/or opportunities of a user associated with the target client 108a-108n may be generated based on the received interaction data signals 116 in conjunction with characteristics of the target client 108a-108n.

As further depicted in FIG. 1, the content generation framework 102 is configured to generate renderable content data objects 114 specific to a target client 108a-108b. The renderable content data objects 114 may include electronic message data, notification data, communication channel data, metadata, and/or other data. The renderable content data objects 114 are selected to elicit a responsive action from the intended target client 108a-108n and/or a user associated with the intended target client 108a-108n and corresponding to a content generation objective. For example, a renderable content data object 114 may request a response, trigger an action at the target client 108a-108n, provide an interface or graphic at a display of the target client 108a-108n, generate a notification, email, text, or other similar electronic communication, and so on. A renderable content data object 114 may invite a user associated with a target client 108a-108n to click a button, open a link, respond to a text or email, purchase a product, or otherwise respond to the electronic communication.

In some embodiments, a renderable content data object 114 may comprise one or more variable interactive action characteristics. Variable interactive action characteristics are one or more characteristics of a content data object that may be adjusted based on the intended target client 108a-108n of the renderable content data object 114. For example, a renderable content data object 114 may include a discount percentage, a voucher amount, a re-use limit, or other similar variable characteristic. In one specific example, a renderable content data object 114 may include a discount percentage on a certain product (e.g., 20% off the product). In another specific example, a renderable content data object 114 may include a voucher amount (e.g., $20 to spend at a particular location). In another specific example, a renderable content data object 114 may include a re-use limit (e.g., limit 5 per customer). One or more of the variable interactive action characteristics may be adjusted based on the target client 108a-108n and determinations of the content generation framework 102.

As further depicted in FIG. 1, the example content generation framework 102 is further configured to receive interaction data signals 116. Interaction data signals 116 refer to one or more data objects or sets of data objects indicating target client characteristics and/or responsive actions executed by the target client 108a-108n receiving the renderable content data object 114. For example, interaction data signals 116 may comprise a data object including indicators of the responsive action taken by the target client 108a-108n. Interaction data signals 116 may indicate whether a renderable content data object 114 was viewed, or otherwise interacted with. Interaction data signals 116 may indicate whether a link was clicked, an item was purchased, a coupon or voucher was redeemed, or other similar data. Interaction data signals 116 may include characteristics of the responsive action, for example, the duration of the responsive action, the input method (e.g., touch, click, voice, etc.) of the responsive action, the electronic device type (e.g., laptop, phone, voice service, etc.) used to interact with the renderable content data object 114, and so on.

As further depicted in FIG. 1, the example content generation framework 102 includes a network 106. The network 106 can be a communications network and/or can be configurable to be embodied in any of a myriad of network configurations. In some embodiments, the network 106 embodies a public network (e.g., the Internet). In some embodiments, the network 106 embodies a private network (e.g., an internal, localized, or closed-off network between particular devices). In some other embodiments, the network 106 embodies a hybrid network (e.g., a network enabling internal communication between particular connected devices and external communication with other devices). The network 106 in some embodiments includes one or more base station(s), relay(s), router(s), switch(es), cell tower(s), communications cable(s) and/or associated routing station(s), and/or the like. In some embodiments, the network 106 includes one or more computing device(s) controlled by individual entities (e.g., an entity-owner router and/or modem) and/or one or more external utility devices (e.g., Internet service provider communication tower(s) and/or other device(s)).

The computing devices of the autonomous content generation system 100 may each communicate in whole or in part over a portion of one or more communication network(s), such as the network 106. For example, each of the components of the autonomous content generation system 100 can be communicatively coupled to transmit data to and/or receive data from one another over the same and/or different wireless or wired networks embodying the network 106. Non-limiting examples of network configuration(s) for the network 106 include, without limitation, a wired or wireless Personal Area Network (PAN), Local Area Network (LAN), Metropolitan Area Network (MAN), Wide Area Network (WAN), and/or the like. Additionally, while FIG. 1 illustrates certain system entities as separate, standalone entities communicating over the communications network(s), the various embodiments are not limited to this particular architecture. In other embodiments, one or more computing entities share one or more components, hardware, and/or the like, or otherwise are embodied by a single computing device such that connection(s) between the computing entities are altered and/or rendered unnecessary. Alternatively, or additionally still, in some embodiments the network 106 enables communication to one or more other computing device(s) not depicted, for example client device(s) for accessing functionality of any of the subsystems therein via native and/or web-based application(s), and/or the like.

As further depicted in FIG. 1, the example content generation framework 102 is configured to receive a user experience content dataset 110. A user experience content dataset 110 refers to one or more data structures mapping one or more features or target client characteristics of a target client 108a-108n to one or more responsive actions performed by the target client 108a-108n. A user experience content dataset 110 is configured to store the target client characteristics of a target client 108a-108n including demographic data and status characteristics, as described herein. The user experience content dataset 110 may include responsive actions logged by the target client 108a-108n including, for example, interaction data signals 116. In some embodiments, the responsive actions of the target client 108a-108n may be associated with a particular renderable content data object 114 presented to the target client 108a-108n.

In some embodiments, a user experience content dataset 110 may comprise an initial user experience content dataset. The initial user experience content dataset may comprise target client 108a-108n data including historical characteristic data captured previous to the launch of the content generation framework 102. In some examples, the initial user experience content dataset may comprise historical target client characteristics of the target client 108a-108n such as demographic data and status characteristics corresponding to associated responsive actions or interaction data signals 116 captured in response to a renderable content data object 114. The initial user experience content dataset may be leveraged during the machine learning training process to update one or more machine learning models comprising the content generation framework 102. In addition, the initial feedback user experience dataset is leveraged by the autonomous feature selection model to generate an initial dynamic framework feature set defining features used by one or more machine learning models comprising the content generation framework 102.

In some embodiments, a user experience content dataset 110 may comprise a feedback user experience content dataset. The feedback user experience content dataset may comprise updated target client characteristics, including responsive actions and interaction data signals 116 in response to one or more renderable content data object 114 provided to the target client 108a-108n. The feedback user experience content dataset may define the current state of the autonomous content generation system 100, including the state of an associated target client 108a-108n. The feedback user experience content dataset may further be leveraged during the machine learning prediction process to periodically update one or more machine learning models comprising the content generation framework 102. In addition, the feedback user experience content dataset is leveraged by the autonomous feature selection model to update the dynamic framework feature set used by one or more machine learning models comprising the content generation framework 102.

As further depicted in FIG. 1, the example content generation framework 102 is configured to receive content generation objectives 112. Content generation objectives 112 include quantifiable parameters utilized by components of the content generation framework 102 to measure the operation of the content generation framework 102. For example, quantifiable client parameters may be included in one or more content generation objectives 112 received at the content generation framework 102. Client parameters may include target client churn (e.g., the number or percent of users associated with target clients 108a-108n who cease interaction with the content generation framework 102 or associated vendor). Other client parameters may include parameters related spending by users associated with a target client 108a-108n, such as user spending over a period of time, total user spending, user spending trends, and so on; return-on-investment (ROI); parameters related to customer retention, such as churn rates, customer purchase frequency, average customer duration, and so on.

The primary objectives of the content generation framework 102 may be included in the content generation objectives 112. For example, a system or computing device may indicate return on investment as a primary objective through one or more content generation objectives 112. In such an instance, a dynamic framework feature set may be selected such that one or more machine learning models comprising the content generation framework 102 are tuned to maximize the return on investment based on the renderable content data objects 114. Similarly, customer churn may be indicated as a primary objective through one or more content generation objectives 112. In such an instance, a dynamic framework feature set may be selected such that one or more machine learning models comprising the content generation framework 102 may be tuned to minimize the customer churn based on the received renderable content data objects 114.

In some embodiments, multiple primary objectives and/or multiple secondary objectives may be provided by the content generation objectives 112. In such an instance, the multiple primary objectives and/or multiple secondary objectives may include weights and/or priorities, indicating a priority of objectives of the content generation framework 102.

The content generation objectives 112 of the autonomous content generation system 100 may include one or more characteristic ranges and/or one or more characteristic step limitations. Characteristic ranges provide limitations and/or guardrails on the parameters of a content data object (e.g., renderable content data object 114). For example, the characteristic ranges of a content generation objective 112 may provide a range of acceptable values of one or more variable interactive action characteristics of a content data object. Similarly, content generation objectives 112 may define a characteristic step limitation for one or more variable interactive action characteristics of the content data object. A characteristic step limitation may be a maximum step size for a variable interactive action characteristic over a defined period. For example, a content generation objective 112, may indicate a voucher amount has a maximum step size of 10% per iteration. Thus, the voucher amount may move up or down only 10% for each iteration of renderable content data object 114 presented to the target client 108a-108n.

Content generation objectives 112 may be provided and updated manually or autonomously. For example, a vendor may manually input content generation objectives 112 via a terminal to the content generation framework 102. One or more of the content generation objectives 112 may further be provided or updated autonomously. For example, based on the manually provided content generation objectives 112, based on industry norms or standards, based on vendor provided parameters, or other similar parameters.

### Example Apparatus

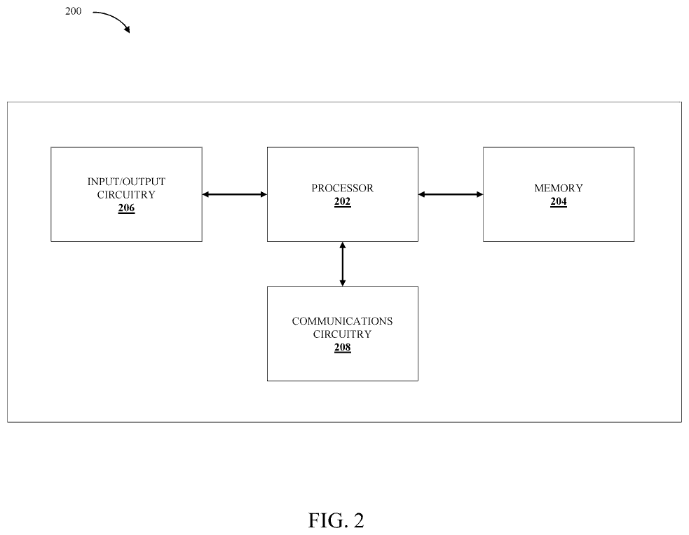

FIG. 2 illustrates a block diagram of an example apparatus 200 that can be specially configured in accordance with at least one example embodiment of the present disclosure. Specifically, FIG. 2 illustrates the content generation framework 102 apparatus in accordance with at least one example embodiment of the present disclosure. The content generation framework 102 apparatus includes processor 202, memory 204, input/output circuitry 206, and communications circuitry 208. In some embodiments, the content generation framework 102 apparatus is configured, using one or more of the sets of circuitry 202, 204, 206, and/or 208, to execute and perform one or more of the operations described herein.

In general, the terms computing entity (or “entity” in reference other than to a user), device, system, and/or similar words used herein interchangeably may refer to, for example, one or more computers, computing entities, desktop computers, mobile phones, tablets, phablets, notebooks, laptops, distributed systems, items/devices, terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably. In this regard, the content generation framework 102 apparatus embodies a particular, specially configured computing entity transformed to enable the specific operations described herein and provide the specific advantages associated therewith, as described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), network interface(s), storage medium(s), and/or the like, to perform their associated functions, such that duplicate hardware is not required for each set of circuitry. The use of the term “circuitry” as used herein with respect to components of the apparatuses described herein should therefore be understood to include particular hardware configured to perform the functions associated with the particular circuitry as described herein.

Particularly, the term “circuitry” should be understood broadly to include hardware and, in some embodiments, software for configuring the hardware. For example, in some embodiments, “circuitry” includes processing circuitry, storage media, network interfaces, input/output devices, and/or the like. Alternatively, or additionally, in some embodiments, other elements of the content generation framework 102 apparatus provide or supplement the functionality of another particular set of circuitry. For example, the processor 202 in some embodiments provides processing functionality to any of the sets of circuitry, the memory 204 provides storage functionality to any of the sets of circuitry, the communications circuitry 208 provides network interface functionality to any of the sets of circuitry, and/or the like.

In some embodiments, the processor 202 (and/or co-processor or any other processing circuitry assisting or otherwise associated with the processor) is/are in communication with the memory 204 via a bus for passing information among components of the content generation framework 102 apparatus. In some embodiments, for example, the memory 204 is non-transitory and may include, for example, one or more volatile and/or non-volatile memories. In other words, for example, the memory 204 in some embodiments includes or embodies an electronic storage device (e.g., a computer readable storage medium). In some embodiments, the memory 204 is configured to store information, data, content, applications, instructions, or the like, for enabling the content generation framework 102 apparatus to carry out various functions in accordance with example embodiments of the present disclosure.

The processor 202 can be embodied in a number of different ways. For example, in some example embodiments, the processor 202 includes one or more processing devices configured to perform independently. Additionally, or alternatively, in some embodiments, the processor 202 includes one or more processor(s) configured in tandem via a bus to enable independent execution of instructions, pipelining, and/or multithreading. The use of the terms “processor” and “processing circuitry” should be understood to include a single core processor, a multi-core processor, multiple processors internal to the content generation framework 102 apparatus, and/or one or more remote or “cloud” processor(s) external to the content generation framework 102 apparatus.

In an example embodiment, the processor 202 is configured to execute instructions stored in the memory 204 or otherwise accessible to the processor. Alternatively, or additionally, the processor 202 in some embodiments is configured to execute hard-coded functionality. As such, whether configured by hardware or software methods, or by a combination thereof, the processor 202 represents an entity (e.g., physically embodied in circuitry) capable of performing operations according to an embodiment of the present disclosure while configured accordingly. Alternatively, or additionally, as another example in some example embodiments, when the processor 202 is embodied as an executor of software instructions, the instructions specifically configure the processor 202 to perform the algorithms embodied in the specific operations described herein when such instructions are executed. In some embodiments, the processor 202 includes or is embodied by a CPU, microprocessor, and/or the like that executes computer-coded instructions, for example stored via the non-transitory memory 204.

In some embodiments, the content generation framework 102 apparatus includes input/output circuitry 206 that provides output to the user and, in some embodiments, to receive an indication of a user input. In some embodiments, the input/output circuitry 206 is in communication with the processor 202 to provide such functionality. The input/output circuitry 206 may comprise one or more user interface(s) and in some embodiments includes a display that comprises the interface(s) rendered as an electronic interface, a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor can be configured to control one or more functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a client device and/or other display associated with a user. In some embodiments, the input/output circuitry 206 includes hardware, software, firmware, and/or a combination thereof, that facilitates simultaneously display of particular data via a plurality of different devices.

In some embodiments, the content generation framework 102 apparatus includes communications circuitry 208. The communications circuitry 208 includes any means such as a device or circuitry embodied in either hardware or a combination of hardware and software that is configured to receive and/or transmit data from/to a network and/or any other device, circuitry, or module in communication with the content generation framework 102 apparatus. In this regard, in some embodiments the communications circuitry 208 includes, for example, a network interface for enabling communications with a wired or wireless communications network. Additionally, or alternatively in some embodiments, the communications circuitry 208 includes one or more network interface card(s), antenna(s), bus(es), switch(es), router(s), modem(s), and supporting hardware, firmware, and/or software, or any other device suitable for enabling communications via one or more communications network(s). Additionally, or alternatively, the communications circuitry 208 includes circuitry for interacting with the antenna(s) and/or other hardware or software to cause transmission of signals via the antenna(s) or to handle receipt of signals received via the antenna(s). In some embodiments, the communications circuitry 208 enables transmission to and/or receipt of data from a client device, capture device, and/or other external computing device in communication with the content generation framework 102 apparatus.

Additionally, or alternatively, in some embodiments, two or more of the sets of circuitries 202-208 are combinable. Alternatively, or additionally, in some embodiments, one or more of the sets of circuitry perform some or all of the functionality described associated with another component. For example, in some embodiments, two or more of the sets of circuitry 202-208 are combined into a single module embodied in hardware, software, firmware, and/or a combination thereof. Similarly, in some embodiments, one or more of the sets of circuitry, is/are combined with the processor 202, such that the processor 202 performs one or more of the operations described above with respect to each of these sets of circuitry 204-208.

### Example Operations

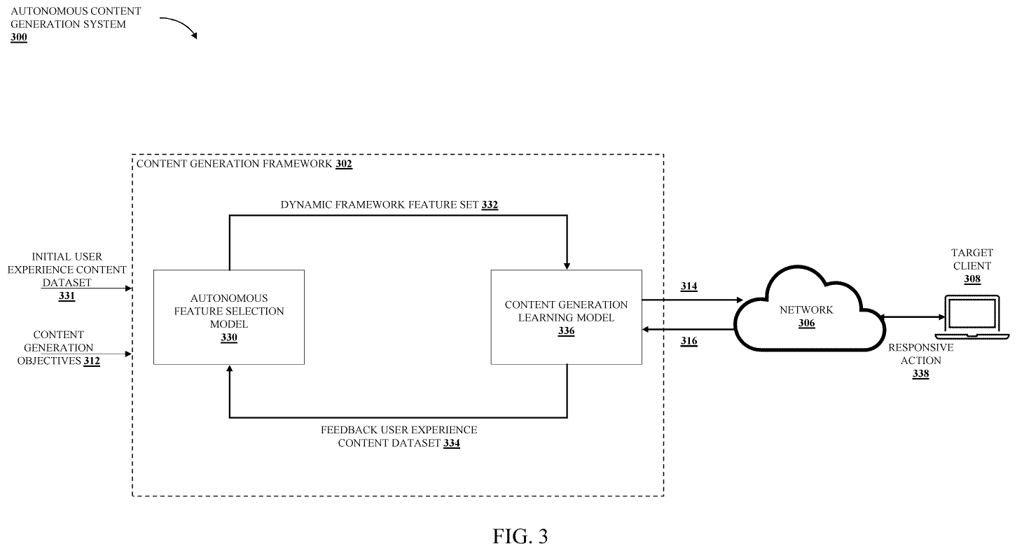

Referring now to FIG. 3, a block diagram of an example content generation framework 302 within an autonomous content generation system 300 is provided. As depicted in FIG. 3, the content generation framework 302 is configured to generate renderable content data objects 314 to be presented to a target client 308 communicatively connected through a network 306. The content generation framework 302 may be configured to receive interaction data signals 116 from the target client 308 based at least in part on one or more responsive actions 338 taken by the target client 308 or a user associated with the target client 308 in response to the renderable content data object 314.

As further depicted in FIG. 3, the content generation framework 302 includes an autonomous feature selection model 330. The autonomous feature selection model 330 executes a process for determining a dynamic framework feature set 332 based on one or more content generation objectives 312, an initial user experience content dataset 331, and/or a feedback user experience content dataset 334. The autonomous feature selection model 330 utilizes a plurality of feature generation mechanisms to generate a plurality of exploratory feature sets, each comprising one or more features (e.g., target client characteristics) obtained from a user experience content dataset (e.g., initial user experience content dataset 331, feedback user experience content dataset 334). An autonomous feature selection model 330 comprises at least one or more list-based feature generation models configured to produce list-based exploratory feature sets, and one or more rank-based feature generation models configured to generate one or more rank-based exploratory feature sets. In addition, an autonomous feature selection model 330 comprises a validation process configured to generate a normalized exploratory feature set score. Selected features of the dynamic framework feature set 332 are selected from the plurality of exploratory feature sets based at least in part on the normalized exploratory feature set score.

In some embodiments, an initial user experience content dataset 331 may be utilized by an autonomous feature selection model 330 to generate an initial dynamic framework feature set 332 based on historical data included in the initial user experience content dataset 331. The performance of the initial dynamic framework feature set 332 may be evaluated based on the content generation objectives 312. For example, the autonomous feature selection model 330 may evaluate a dynamic framework feature set 332 by testing the performance of a content generation learning model 336 utilizing the dynamic framework feature set 332 against the initial user experience content dataset 331.

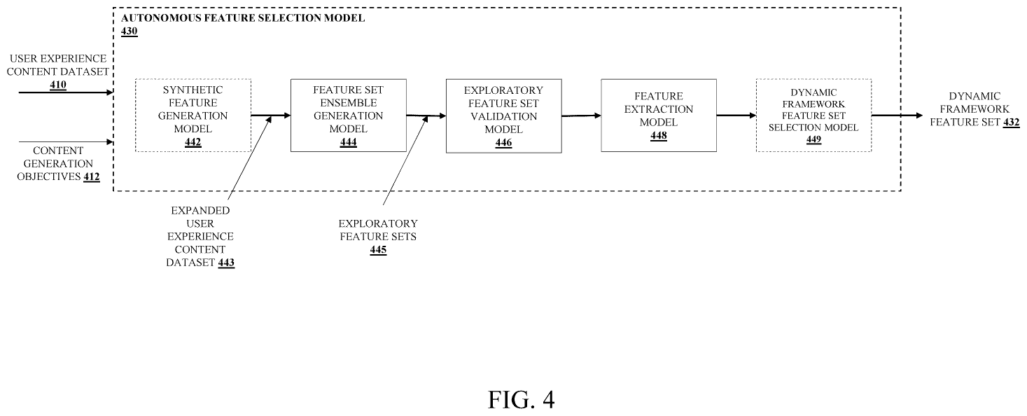

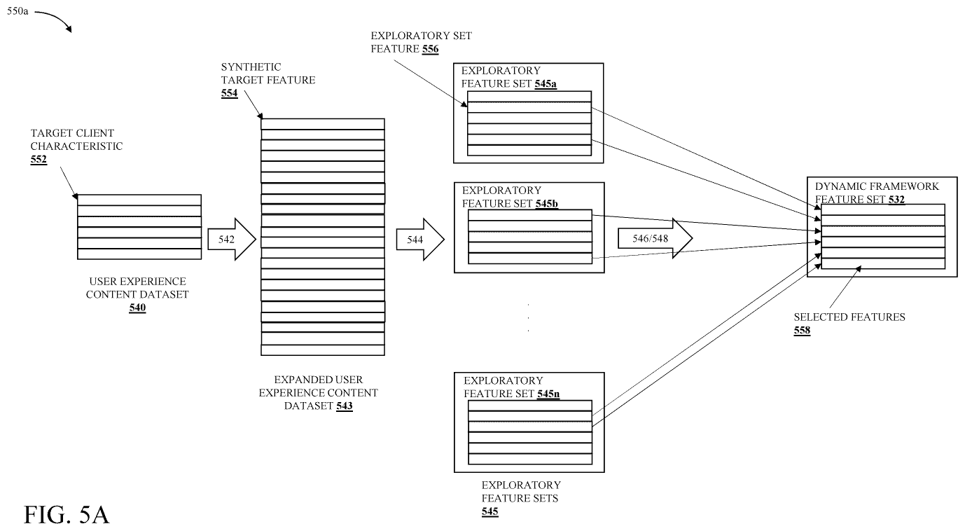

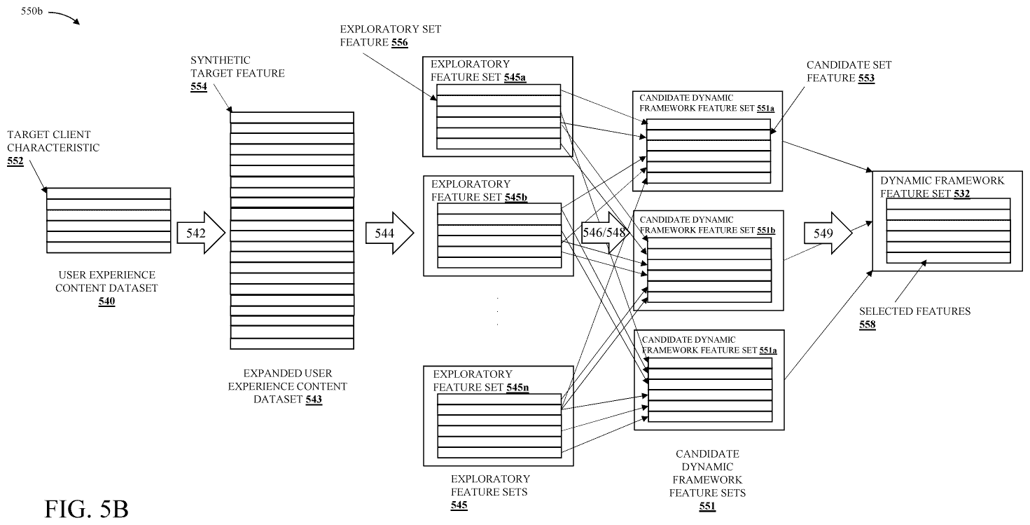

A feedback user experience content dataset 334 is received by the autonomous feature selection model 330 periodically during the machine learning prediction process. A feedback user experience content dataset 334 is generated by the content generation learning model 336 based at least in part on interaction data signals 316 received from one or more target clients 308. The feedback user experience content dataset 334 includes a learning model state relating to the state of the target client 308, including target client characteristics and responsive actions 338 performed by the target client 308. The feedback user experience content dataset 334 may be utilized by the autonomous feature selection model 330 to update one or more of the selected features comprising the dynamic framework feature set 332 based on the learning model state and associated responsive actions 338. Example embodiments of an autonomous feature selection model 330 are further described in relation to FIG. 4 and FIG. 5A-FIG. 5B.

The dynamic framework feature set 332 refers to one or more feature sets generated by an autonomous feature selection model 330, such that the selected features comprising the dynamic framework feature set 332 are configured to improve predicted outcomes relative to one or more content generation objectives 112. The autonomous feature selection model 330 may determine the number and combination of selected features generating the most accurate predicted outcomes. In some embodiments, one or more parameters of the dynamic framework feature set 332 may include a range or limitation. For example, the number of selected features in a dynamic framework feature set 332 may be fixed to a particular value or range. A user may identify ranges or limitations on the number, type, and combinations of features through the content generation objectives 112 or other similar input mechanism.

In some embodiments, an updated dynamic framework feature set 332 may be compared to previous dynamic framework feature sets 332 to determine if the updated dynamic framework feature set 332 performs better than the dynamic framework feature set 332 previously deployed. For example, an updated dynamic framework feature set 332 may be utilized to test results on historical user experience content datasets. In an instance in which the performance of the updated dynamic framework feature set 332 does not exceed the performance of the previously deployed dynamic framework feature set 332, the updated dynamic framework feature set 332 may be abandoned.

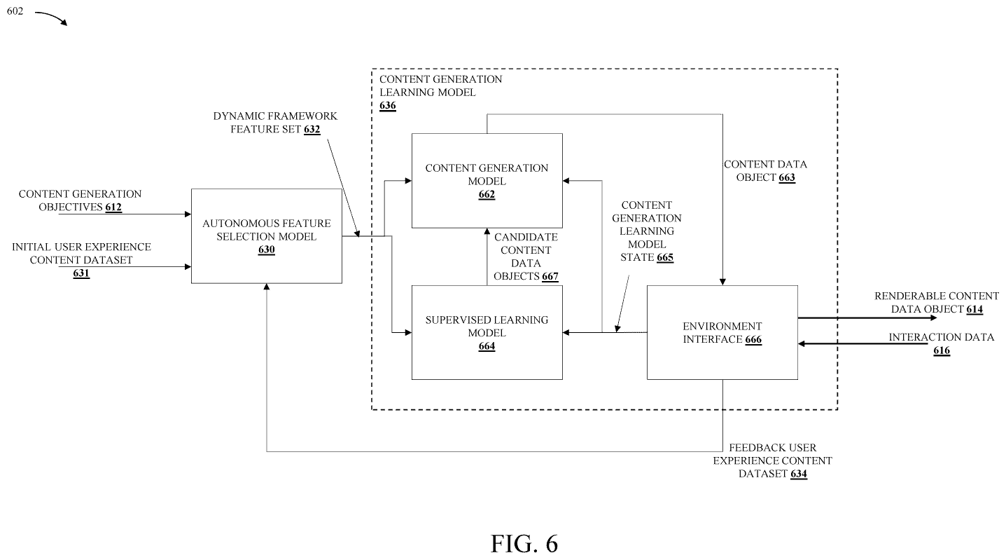

As further depicted in FIG. 3, the content generation framework 302 includes a content generation learning model 336. The content generation learning model 336 is configured to generate custom renderable content data objects 314 based at least in part on the output of one or more machine learning models. The content generation learning model 336 is configured to receive learning model state data representative of the state of a target client 308, for example, an initial user experience content dataset 331 and/or interaction data signals 316. The content generation learning model 336 may be configured to receive one or more content generation objectives 312. The content generation learning model 336 determines a content data object in accordance with the one or more content generation objectives 312 based on the learning model state of the target client 308. The content data object is presented at the target client 308 as a renderable content data object 314. The content generation learning model 336 may be configured to receive one or more interaction data signals 316 indicative of one or more responsive actions 324 of the target client 308. The content generation learning model may generate a feedback user experience content dataset 334 based at least in part on the interaction data signals 316. An example embodiment of a content generation learning model 336 is described in relation to FIG. 6.

As further depicted in FIG. 3, the content generation framework 302 may receive one or more responsive actions 338 performed by the target client 308. A responsive action 338 refers to one or more data signals transmitted by a target client 308 representing an action taken by the target client 308, and/or a user associated with the target client, in response to receiving a renderable content data object 314. A responsive action 338 may be performed by a target client 308, a user or entity associated with the target client 308, or any other user or device interacting with the target client 308. In some embodiments, the dynamic framework feature set 332 may be generated to maximize the likelihood of eliciting a responsive action 338 indicated by one or more content generation objectives 312.

Referring now to FIG. 4, a block diagram of an example autonomous feature selection model 430 is provided. As depicted in FIG. 4, the autonomous feature selection model 430 is configured to access a user experience content dataset 410 and content generation objectives 412 to generate a dynamic framework feature set 432 comprising one or more selected features optimized to generate accurate predictions related to one or more content generation objectives 412. As further depicted in FIG. 4, the example autonomous feature selection model 430 includes a synthetic feature generation model 442 configured to generate an expanded user experience content dataset 443. The autonomous feature selection model 430 may include a feature set ensemble generation model 444 configured to generate exploratory feature sets 445 based on the expanded user experience content dataset 443. The exploratory feature sets 445 are assigned a normalized exploratory feature set score by an exploratory feature set validation model 446. As further depicted, a feature extraction model 448 selects one or more selected features from the exploratory feature sets 445 based at least in part on the normalized exploratory feature set score associated with each exploratory feature set of the plurality of exploratory feature sets 445.

As depicted in FIG. 4, the example autonomous feature selection model 430 includes a feature set ensemble generation model 444. The feature set ensemble generation model 444 accesses a collection of features to generate a plurality of exploratory feature sets 445 each comprising one or more exploratory set features (e.g., exploratory set feature 556 described in relation to FIG. 5A-FIG. 5B). Each exploratory feature set 445 is based on one or more feature generation models. The collection of exploratory set features comprising an exploratory feature set 445 may be any set of data, for example, data derived from a user experience content dataset 410 and/or an expanded user experience content dataset 443. A feature set ensemble generation model 444 may include a plurality of feature generation models, each configured to generate one or more sets of features comprising features from the collection of features. A feature set ensemble generation model 444 may be implemented utilizing any number of feature generation models comprising any feature generation type.

The feature set ensemble generation model 444 may be configured to generate at least one list-based exploratory feature set of the plurality of exploratory feature sets 445 utilizing a list-based feature generation model. A list-based feature generation model refers to one or more processes, algorithms, or other similar mechanisms configured to generate a subset of features (e.g., exploratory set features) from the collection of features available to the feature set ensemble generation model 444 such that the likelihood of one or more content generation objectives 412 is maximized. For example, a list-based feature generation model may determine combinations of features selected from the collection of features that uncover hidden insights and trends in a dataset.

In some examples, a list-based feature generation model may utilize an optimization algorithm to generate various sets of features and test the resulting set of features based on historical outcome data. For example, a list-based feature generation model may utilize a genetic feature selection algorithm to generate one or more exploratory feature sets. A genetic feature selection algorithm may utilize the principles of genetics and evolution to generate one or more improved solutions over a series of iterations. A genetic feature selection algorithm may start with a population of randomly generated individuals (e.g., feature sets) comprising a set of properties (e.g., features). With each generation, individuals may be combined, mutated, or otherwise altered to create a new population of individuals. The new population of individuals may be tested for fitness (e.g., the performance of a machine learning model based on the feature set may be evaluated based on the content generation objectives 412). The new population may be reduced based on the fitness of each individual. The genetic feature selection algorithm may be repeated for a set number of generations, until a certain fitness level is reached, or based on another similar metric. Utilizing a genetic feature selection algorithm may result in one or more exploratory feature sets 445 comprising a subset of features optimized such that a machine learning model may predict accurate outcomes relative to one or more content generation objectives.

Other optimization models may be utilized by a list-based feature generation model to generate one or more exploratory feature sets 445, for example, including but not limited to other evolutionary models, linear programing, simulated annealing, Gaussian adaptation, hill climbing, swarm intelligence, recursive feature elimination, and random forest models. Although described as a subset, an exploratory feature set generated utilizing a list-based feature generation model may include all of the features in the collection of features.

The feature set ensemble generation model 444 may generate at least one rank-based exploratory feature set of the plurality of exploratory feature sets 445 utilizing a rank-based feature generation model. A rank-based feature generation model refers to one or more processes, algorithms, or other similar mechanisms configured to generate a ranking or priority of features (e.g., exploratory set features) from the collection of features available to the feature set ensemble generation model 444 such that a high rank or priority corresponds to a feature highly correlated with one or more content generation objectives 412. A rank-based feature generation model may be configured to generate a rank-based feature score for each feature comprising the rank-based exploratory feature set. The rank-based feature score may represent the likelihood that the feature revels insights and/or trends in a dataset. For example, a rank-based feature generation model may determine rank or prioritize a plurality of features from the collection of features based on the rank-based feature score.

In some examples, a rank-based feature generation model may utilize a filter-based method to generate a ranked list of features. A filter-based method may utilize statistical tests to determine a correlation between a feature and a desired content generation objective 412. For example, in some embodiments, a chi-square feature selection algorithm may be used to rank the collection of features. A chi-square feature selection algorithm calculates a chi-square value between the observed content generation objective 412 and the predicted outcome based on a particular feature in the collection of features. The collection of features are ranked based on the chi-square value of each feature in the collection of features. Other filter-based methods for generating a ranked list of features may include, but are not limited to, mutual information classifiers, analysis of variance (ANOVA) F-value classifiers, Fisher scores, and any other filter-based method. In addition, relief feature selection methods, such as MultiSurf and similar methods, may be utilized to generate a ranked list of features. In some embodiments, a filter-based ranking process may include a predetermined threshold and/or minimum number of features around which to generate a ranked list.

The feature set ensemble generation model 444 may utilize dimensionality reduction techniques in the generation of the synthetic features (e.g., the expanded user experience content dataset 443 via the synthetic feature generation model 442) and/or generation of feature sets (e.g., the one or more exploratory feature sets 445 via the feature set ensemble generation model 444). Dimensionality reduction techniques include techniques designed to reduce the size of a data set, such as a feature set, based on statistical determinations. In some embodiments, the dimensionality reduction techniques may be used (e.g., as part of the exploratory feature set creation) to output additional exploratory feature sets. For example, new features may be generated based on a plurality of features included in the user experience content dataset. Non-limiting examples of dimensionality reduction techniques may include principal component analysis, linear discriminant analysis, multidimensional scaling, independent component analysis, t-Distributed stochastic neighbor embedding, auto encoders, and manifold learning (such as isomap). Dimensionality reduction techniques may enable the generation of dynamic framework feature sets 432 providing adequate information to generate predicted outcomes with a reduced number of included features. Example dimensionality reduction techniques according to various embodiments described herein may include supervised and/or unsupervised techniques and may include linear and/or non-linear techniques.

In addition to utilizing rank-based feature generation models, list-based feature generation models, and dimensionality reduction techniques to generate exploratory feature sets, other feature generation models or feature-generation-related processes may be used, and some methods may fall into multiple categories. Example models and processes include other filter methods (e.g., Fisher's score, correlation coefficient, means absolute difference, dispersion ratio), wrapper methods (e.g., forward feature selection, exhaustive feature selection, recursive feature elimination, permutation importance, Shapely Additive Explanations (SHAP), Boruta), embedded methods (e.g., least absolute shrinkage and selection operator regularization, random forest importance), and/or hybrid methods (e.g., a filter method that filters the features according to some metric and a threshold to generate a list that is a subset of the starting feature set).

As depicted in FIG. 4, the feature set ensemble generation model 444 is configured to generate a plurality of exploratory feature sets 445. A plurality of exploratory feature sets 445 refers to one or more groups or collections of feature sets generated by one or more feature generation models of the feature set ensemble generation model 444. In some embodiments, the plurality of exploratory feature sets 445 may comprise a fixed number of exploratory feature sets, for example, one exploratory feature set generated by each feature generation model. The plurality of exploratory feature sets 445 are analyzed by the exploratory feature set validation model 446 to generate a normalized exploratory feature set score for each exploratory feature set of the plurality of exploratory feature sets 445.

As further depicted in FIG. 4, the autonomous feature selection model 430 includes an exploratory feature set validation model 446. The exploratory feature set validation model 446 is configured to determine a normalized exploratory feature set score for each exploratory feature set in the plurality of exploratory feature sets 445. A normalized exploratory feature set score refers to one or more quantifications, priorities, or rankings, indicating a relative priority of each exploratory feature set based on the likelihood of generating an accurate predicted outcome relative to a content generation objective 412. For example, a high normalized exploratory feature set score may indicate a high likelihood that the content generation objective 412 will be realized. A normalized exploratory feature set score is normalized such that each exploratory feature set of the plurality of exploratory feature sets 445 may be directly compared. A relative priority may be determined based on the normalized exploratory feature set score.

In addition to or instead of assigning scores to each exploratory feature set as a whole, the exploratory feature set validation model 446 may generate an exploratory feature score for one or more exploratory set features of the exploratory feature sets 445 (e.g., individual scoring of one or more features within an exploratory feature set). An exploratory feature score may refer to a quantification, priority, ranking, or other measure of an exploratory set feature, for example, indicating a likelihood of generating an accurate predicted outcome relative to a content generation objective 412 in some embodiments. In some embodiments, the exploratory feature set validation model 446 may assign the exploratory feature set score determined for an exploratory feature set 445 to one or more exploratory set features making up the exploratory feature set 445.

The exploratory feature set validation model 446 may utilize the score or ranking from each exploratory set feature to determine an overall exploratory feature set score for each exploratory set feature. For example, the exploratory feature set validation model 446 may accumulate or average exploratory feature set scores for each exploratory set feature across each instance that the respective feature appears in a plurality of exploratory feature sets 445. Thus, an exploratory feature score may be correlated with each feature based on the accumulation and/or average of the exploratory feature scores for the exploratory set feature across the plurality of exploratory feature sets 445. In such embodiments, individual features may be rated separate from their underlying feature sets, and features that were suggested more will have more scores associated with them, which may cause a higher total score for these features. An exploratory feature set score calculated for each feature may be utilized to select a particular exploratory set feature for inclusion in a dynamic framework feature set 432 (e.g., either by selecting a pre-existing exploratory feature set based on the foregoing analysis or by assembling a new feature set as the dynamic framework feature set based on the individual feature rankings). For example, the exploratory set features having the highest accumulated normalized score, or the highest average normalized feature set score, may be an indicator for inclusion in the dynamic framework feature set 432. In some embodiments, for example, features with scores above of a predetermined threshold and/or a top set (e.g., top 20 features) can be combined into one or more dynamic framework feature sets (including candidate dynamic framework feature sets for an additional validation process as discussed herein).

An exploratory feature set validation model 446 may use any scoring mechanism to generate a normalized exploratory feature set score for each exploratory feature set and/or an exploratory feature score for each exploratory set feature.

For example, the exploratory feature set validation model 446 may generate predicted outcomes using a machine learning model trained with the features included in an exploratory feature set based on historical learning model state data for a vendor utilizing the content generation framework. The predicted outcomes may then be compared to the historically observed outcomes. The performance of the machine learning model based on the exploratory feature set may be quantified, and a normalized exploratory feature set score and/or relative priority assigned.

In some embodiments, the exploratory feature set validation model 446 may generate predicted outcomes using a machine learning model according to various embodiments herein trained with an exploratory feature set based on historical data derived from the vendor from which the data originates or from other vendors (e.g., vendors sharing the same or a similar classification). For example, data associated with a similar vendor may be used in place of or to augment the historical learning model state data for the vendor utilizing the content generation data. The predicted outcomes may then be compared to the historically observed outcomes for the vendor and/or other vendors as well as other predicted outcomes for other exploratory feature sets and exploratory features. The performance of the machine learning model based on the exploratory feature set may be quantified, and assignment of a normalized exploratory feature set score and/or relative priority for validating the exploratory features and exploratory feature sets.

The exploratory feature set validation model 446 may be configured to generate normalized exploratory feature set scores and/or exploratory feature scores based on the predicted performance of the exploratory feature set and/or exploratory set feature during future deployment using one or more predictive quantification methods. One predictive quantification method may include withholding a portion of the historical learning model state data during training of the machine learning model. In such an instance, the exploratory feature set validation model 446 may generate predicted outcomes using a machine learning model on the withheld data. Thus, predicted outcomes based on the generated exploratory feature sets may not be biased by the training data. The predicted outcomes may then be compared to the historically observed outcomes for the withheld data. The performance of the machine learning model based on the exploratory feature set may be quantified, and a normalized exploratory feature set score and/or relative priority assigned.

Another predictive quantification method may include withholding a most recent portion of the historical learning model state data during training of the machine learning model. For example, a most recent month of historical data may be withheld, and the machine learning model(s) may be trained on the historical data corresponding to the exploratory feature set(s) preceding the most recent month. In such an instance, the exploratory feature set validation model 446 may generate predicted outcomes using a machine learning model on the most recent portion of the historical learning model state data. The predicted outcomes for the most recent portion may then be compared to the historically observed outcomes for the most recent portion of data (e.g., the trained machine learning model may then be run on the most recent month's data and the prediction generated thereby may be compared with the actual data from the most recent month to determine the predictiveness of the exploratory feature set(s) and/or exploratory features). The performance of the machine learning model based on the exploratory feature set may be quantified, and a normalized exploratory feature set score and/or relative priority assigned.

Further predictive quantification methods may include determining a normalized exploratory feature set score and/or exploratory feature score based on a statistical model of the performance of a machine learning model trained utilizing a given exploratory feature set 445. For example, a weighted precision-recall curve may be generated to illustrate the tradeoff between precision and recall with respect to a changing threshold. As used in the model, precision is a measure of the relevancy of results returned by the machine learning model, and recall is a measure of the quantity of relevant results returned by the machine learning model. Various results may be derived from a precision-recall curve that may be utilized to measure the success of the machine learning model with the tested exploratory feature sets during future deployment. For example, an area under the precision-recall curve may indicate the success of the machine learning model trained with the selected exploratory feature set. In another example, an F-score or F-value may be determined based on the precision-recall curve. In some embodiments an F1 score (e.g., a harmonic mean of the precision and recall scores) may be used. Additional calculations may be determined based on a statistical model of the performance of a machine learning model trained utilizing a given an exploratory feature set 445 to determine the exploratory feature set score and/or exploratory feature score for the given exploratory feature set 445. As further depicted in FIG. 4, the autonomous feature selection model 430 includes a feature extraction model 448. A feature extraction model 448 is any circuitry including hardware and/or software configured to select one or more exploratory set features from the plurality of exploratory feature sets 445 for inclusion in the dynamic framework feature set 432, based at least in part on the normalized exploratory feature set score associated with each of the exploratory feature sets. A feature extraction model 448 may utilize one or more processes, algorithms, or other mechanisms for selecting exploratory set features for inclusion in the dynamic framework feature set 432.

In one example embodiment, the feature extraction model 448 may select exploratory set features from the plurality of exploratory feature sets 445 based on a correlation of exploratory set features between the exploratory feature sets. For example, the feature extraction model 448 may select the most commonly occurring exploratory set features appearing in the plurality of exploratory feature sets 445. Alternatively, the feature extraction model 448 may select exploratory set features that are unique amongst the plurality of exploratory feature sets 445.

In one example embodiment, exploratory feature set validation model 446 may assign a highest normalized exploratory feature set score to the exploratory feature set associated with a highest likelihood of correctly predicting the responsive action of a target client to a renderable content generation object. In some embodiments, the feature extraction model 448 may select the exploratory feature set of the plurality of exploratory feature sets 445 associated with the highest normalized exploratory feature set score as the dynamic framework feature set 432.

In one example embodiment, the feature extraction model 448 may select all of the exploratory set features contained in the plurality of exploratory feature sets 445.

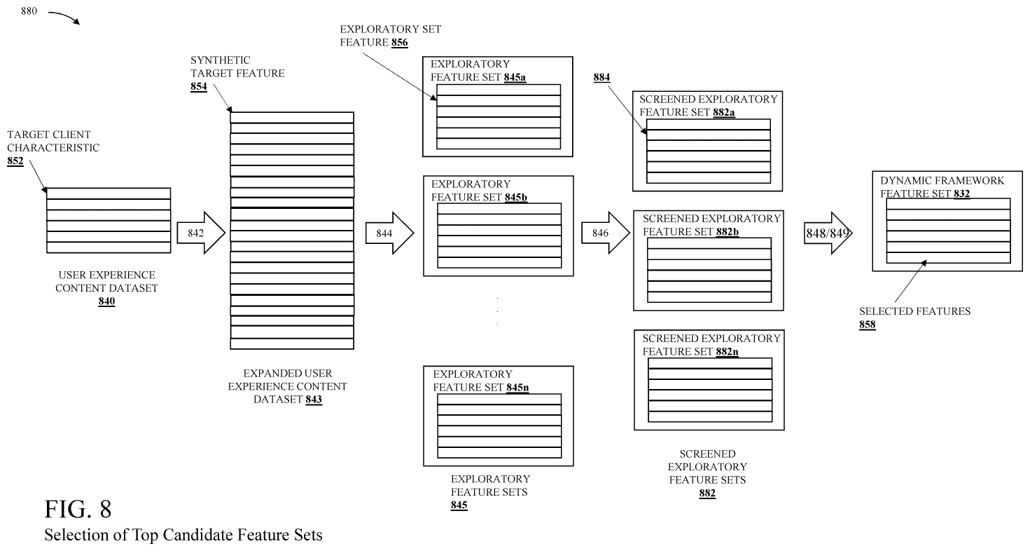

In one example embodiment, the feature extraction model 448 may select a subset of exploratory feature sets from the plurality of exploratory feature sets 445 based on the normalized exploratory feature set score of the exploratory feature sets. The feature extraction model 448 may select exploratory set features from the subset of exploratory feature sets to be included in the dynamic framework feature set 432. An example embodiment illustrating a selection of exploratory set features from a subset of exploratory feature sets is described in relation to FIG. 8.

In one example embodiment, the feature extraction model 448 may select exploratory set features based on the exploratory feature score for each exploratory set feature. For example, the feature extraction model 448 may select a pre-determined number of exploratory set features having the highest accumulative or average exploratory feature score. In some embodiments, all combinations of features may be tested, and a subset or subsets of features may be selected based on a predetermined target feature set quantity. In such embodiments, in an instance in which the total set of features is now minimal, feature sets may be used as an embedded feature selection method to determine from these final sets of features (e.g., aggregated from all the exploratory feature sets) which subset(s) of a predetermined size are best for optimizing the model on the resulting dataset.

In some embodiments, the feature extraction model 448 may select exploratory set features from the plurality of exploratory feature sets 445 based on a statistical distribution. For example, a number of exploratory set features may be randomly selected from the highest scoring exploratory feature set. In some embodiments, another number of exploratory set features from the next highest scoring exploratory feature set. In some embodiments, the feature extraction model 448 may randomly select exploratory set features from the plurality of exploratory feature sets 445.

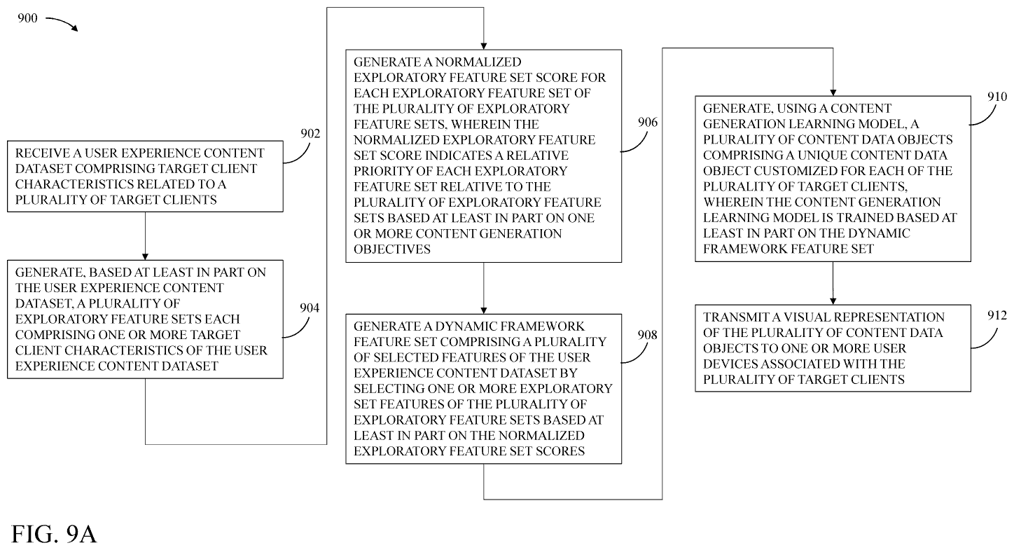

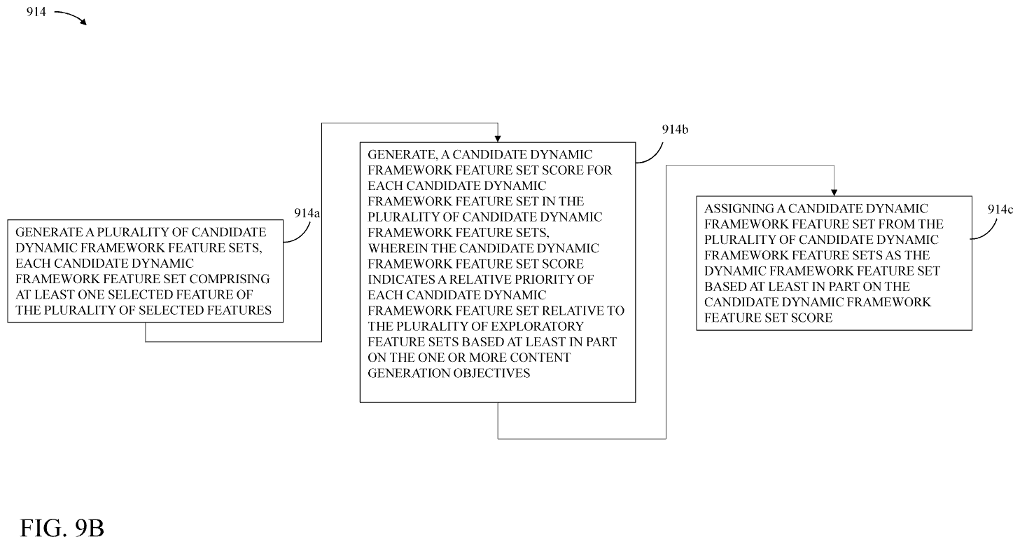

Some embodiments of the present disclosure include a second validation process whereby the contributions of the exploratory features and/or exploratory feature sets are validated for their contribution to the final dynamic framework feature set to generate the best combined dynamic framework feature set rather than the sum of the best parts in isolation. In such embodiments, the feature extraction model 448 may generate a plurality of candidate dynamic framework feature sets (e.g., candidate dynamic framework feature sets 551 as depicted in FIG. 5B) utilizing one or more feature selection mechanisms. For example, an autonomous feature selection model 430 may utilize various feature selection mechanisms to select exploratory set features from the plurality of exploratory feature sets 445, each feature selection mechanism generating a unique candidate dynamic framework feature set. In such an instance, the autonomous feature selection model 430 may include a dynamic framework feature set selection model 449 to determine a dynamic framework feature set 432 from the plurality of candidate dynamic framework feature sets. A dynamic framework feature set selection model 449 refers to one or more processes, algorithms, or other similar mechanisms configured to perform a validation of the candidate dynamic framework feature sets 551 to select a dynamic framework feature set 432 (e.g., an optimized feature set having a highest score) from a plurality of candidate dynamic framework feature sets. Generation of a dynamic framework feature set 432 utilizing a plurality of candidate dynamic framework feature sets is described further in relation to FIG. 9B.

In some embodiments, the feature extraction model 448 may analyze the dynamic framework feature set 432 previous to deploying the dynamic framework feature set 432 for use on a machine learning model. For example, the feature extraction model 448 may generate predicted outcomes using a machine learning model trained with the features included in the dynamic framework feature set 432 based on historical data. The predicted outcomes may then be compared to the historically observed outcomes. In an instance in which the dynamic framework feature set 432 performs worse than the feature set currently utilized by the deployed machine learning model, the feature extraction model 448 may re-select the features and/or retain the feature set currently utilized by the deployed machine learning model.

The feature extraction model 448 may be configured to generate a plurality of dynamic framework feature sets 432 in the content generation framework. In some embodiments, the content generation objectives 412 may comprise a plurality of content generation objectives 412. A feature extraction model 448 may generate a dynamic framework feature set 432 for each content generation objective. For example, a first content generation objective 412 may be to minimize target client churn (e.g., the number or percent of users associated with target clients who cease interaction with an associated vendor). The autonomous feature selection model 430 may be configured to generate normalized exploratory feature set scores, exploratory feature scores, and/or candidate dynamic framework feature set scores based on the first content generation objective 412. A first dynamic framework feature set 432 may be generated based on the scores relative to the first content generation objective 412. A second content generation objective 412 may be to maximize total user spending. The autonomous feature selection model 430 may be configured to generate additional normalized exploratory feature set scores, exploratory feature scores, and/or candidate dynamic framework feature set scores based on the second content generation objective 412. A second dynamic framework feature set 432 may be generated based on the scores relative to the second content generation objective 412.

Although primarily described in relation to a supervised machine learning model, the autonomous feature selection model may be configured to generate a dynamic framework feature set 432 for an unsupervised machine learning model. In such an instance, the exploratory feature set validation model 446 and feature extraction model 448 may utilize scoring tactics specifically designed for the unsupervised machine learning model to generate normalize exploratory feature set scores, exploratory feature scores, and/or candidate dynamic framework feature set scores utilized to analyze performance and select exploratory set features for inclusion in a dynamic framework feature set.

As further depicted in FIG. 4, in some embodiments, the autonomous feature selection model 430 may include a synthetic feature generation model 442. The synthetic feature generation model 442 may utilize one or more processes, algorithms, or other mechanisms to expand the feature set comprising the user experience content dataset 410 to generate an expanded user experience content dataset 443. For example, the synthetic feature generation model 442 may access additional features related to the target client to include in the expanded user experience content dataset 443, such as weather data, geo-location data, etc. Additionally, the synthetic feature generation model 442 may combine one or more features comprising the user experience content dataset 410. In addition, the synthetic feature generation model 442 may generate synthetic target features based on statistical relationships between one or more features. For example, one or more features may be averaged, added, subtracted, or otherwise combined to create a new feature for inclusion in the expanded user experience content dataset 443. Similarly, standard deviations, variances, and other statistical values may be determined and included in the expanded user experience content dataset 443. Such techniques may be applied not only to individual features but also to combinations of features. For example, a maximum of two features may be multiplied together. As another, non-limiting example, a minimum of one feature may be subtracted from the another only if some third feature is above some threshold over the last predetermined time period (e.g., six months). The synthetic feature generation model 442 may utilize historical data to determine features based on changes in a particular feature over time. The synthetic feature generation model 442 may be particularly useful in a data-constrained environment.

As further depicted in FIG. 4, the synthetic feature generation model 442 may be configured to generate an expanded user experience content dataset 443. An expanded user experience content dataset 443 refers to one or more sets of features comprising one or more features derived from the user experience content dataset 410 (e.g., initial user experience content dataset, feedback user experience content dataset) using a synthetic feature generation model 442. In some embodiments, the expanded user experience content dataset 443 may include all of the features of the user experience content dataset 410 plus the synthetic features generated by the synthetic feature generation model 442. In an instance in which an autonomous feature selection model 430 utilizes a synthetic feature generation model 442, the feature set ensemble generation model 444 may generate the plurality of exploratory feature sets 445 based at least in part on the expanded user experience content dataset 443.

Referring now to FIG. 5A, an example flow diagram illustrating an example process 550a for generating a dynamic framework feature set 532 is provided. As depicted in FIG. 5A, a synthetic feature generation model 542 accesses a user experience content dataset 540 comprising one or more target client characteristics 552 and generates an expanded user experience content dataset 543 including a plurality of synthetic target features 554. As further depicted in FIG. 5A, a feature set ensemble generation model 544 generates a plurality of exploratory feature sets 545 each comprising one or more exploratory set features 556. The plurality of exploratory feature sets 545 are associated with a normalized exploratory feature set score as determined by an exploratory feature set validation model 546. Exploratory set features 556 are selected by a feature extraction model 548. The selected features 558 comprise the dynamic framework feature set 532.

As depicted in FIG. 5A, the example process 550a for generating a dynamic framework feature set 532 includes providing access to a user experience content dataset 540 comprising one or more target client characteristics 552. As described herein, a user experience content dataset 540 may comprise an initial user experience content dataset including historical target client characteristics 552 and associated responsive actions or other outcomes. An initial user experience content dataset may be utilized by the autonomous feature selection model as a training dataset during the machine learning training process.

As further described herein, a user experience content dataset 540 may comprise a feedback user experience content dataset. A feedback user experience content dataset may comprise target client characteristics 552 related to one or more current target clients. A feedback user experience content dataset may be continually updated to reflect the current state of the target clients and the machine learning environment in which the target clients are operating. A feedback user experience content dataset may be utilized by the autonomous feature selection model as a machine learning environment dataset during the machine learning prediction process. The autonomous feature selection model 430 may periodically update the dynamic framework feature set 532 for a set of target clients based on an updated feedback user experience content dataset.

Although depicted as comprising a set of target client characteristics 552, the user experience content dataset 540 may include any features representing the current or historical state of one or more target clients, and/or the machine learning environment in which the one or more target clients are operating.

As further depicted in FIG. 5A, the synthetic feature generation model 542 is configured to generate an expanded user experience content dataset 543 comprising one or more synthetic target features 554. Synthetic target features 554 are any features provided in the user experience content dataset 540 and/or generated by the synthetic feature generation model 542. For example, in some embodiments, the synthetic target features 554 may comprise the target client characteristics 552 provided to the synthetic feature generation model 542 and the synthetic features generated by the synthetic feature generation model 542. In the depicted example embodiment of FIG. 5A, the expanded user experience content dataset 543 contains more features (e.g., synthetic target features) than the user experience content dataset 540. Providing more features for the feature set ensemble generation model 544 to select from may enable the generation of a large volume and highly varied exploratory feature sets 545a-545n. The larger set of features available in the expanded user experience content dataset 543 may enable rapid improvements in the performance of a content generation framework utilizing a synthetic feature generation model 542 in an autonomous feature selection model. The larger set of features available in the expanded user experience content dataset 543 may be particularly useful in a data-constrained environment.

In some embodiments, a synthetic feature generation model 542 is not used as part of the process 550a. In such an embodiment, the user experience content dataset 540 is directly accessible by the feature set ensemble generation model 544. Features may be accessed directly from the user experience content dataset 540 during generation of the plurality of exploratory feature sets 545.

As further depicted in FIG. 5A, the feature set ensemble generation model 544 is configured to generate exploratory feature sets 545a-545n. Each exploratory feature set 545a-545n comprises one or more exploratory set features 556 selected from the expanded user experience content dataset 543. Exploratory set features 556 include any of the synthetic target features 554 included in the expanded user experience content dataset 543. As described in relation to FIG. 5A, the feature set ensemble generation model 544 may utilize various feature generation models to generate exploratory feature sets 545a-545n including a list-based feature generation model, a rank-based feature generation model, dimensionality reduction techniques, and/or any combination thereof. By way of non-limiting example, embodiments of the framework disclosed herein could execute one list-based feature generation model; two list-based feature generation models with further decision making on the subsets of those two; two rank-based models; or the like. Each exploratory feature set 545a-545n may comprise a different number of exploratory set features 556 depending on the feature generation model used to generate the exploratory feature set 545a-545n. For example, some exploratory feature sets 545a-545n may comprise fifty features, others one-hundred features, and still others may comprise all of the available synthetic target features 554. Further, some exploratory feature sets 545a-545n may be generated by a list-based feature generation model, some by a rank-based feature generation model, some by a selection algorithm incorporating a random input, and/or combinations thereof. Generation of a variety of exploratory feature sets 545a-545n comprising a plurality of generation methods may greatly improve the accuracy and reliability of a content generation framework utilizing machine learning models trained and classifying based on the dynamic framework feature set 532.

As further depicted in FIG. 5A, an exploratory feature set validation model 546 associates a normalized exploratory feature set score for each exploratory feature set 545a-545n generated by the feature set ensemble generation model 544. In addition, the feature extraction model 548 selects one or more exploratory set features 556 from the plurality of exploratory feature sets 545 to generate a dynamic framework feature set 532. As described herein, a normalized exploratory feature set score may establish a relative priority between the exploratory feature sets 545a-545n comprising the plurality of exploratory feature sets 545 and/or the exploratory set features 556 comprising the exploratory feature sets 545a-545n. For example, each exploratory feature set 545a-545n may receive a normalized exploratory feature set score indicating a likelihood a trained machine learning model in the content generation framework will predict accurate outcomes with respect to a content generation objective.

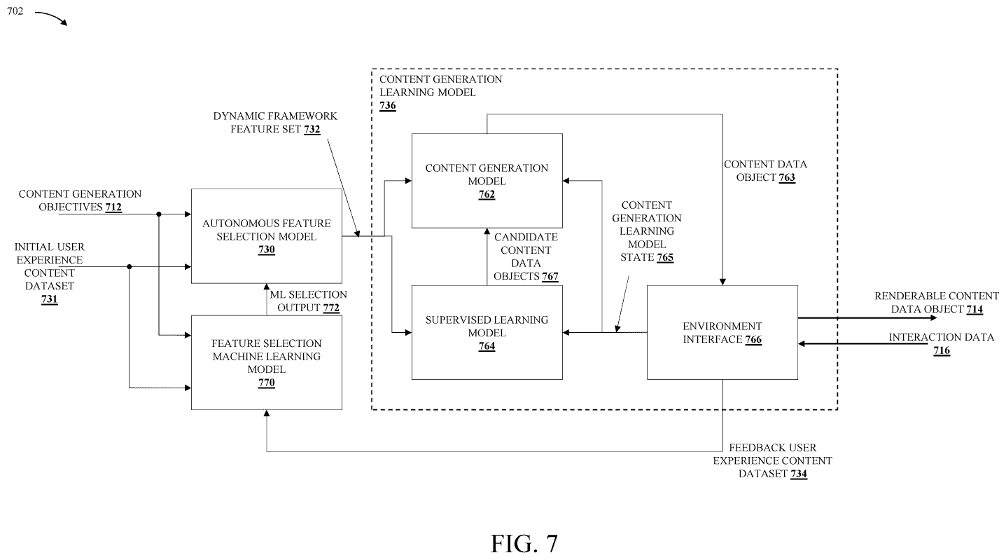

The feature extraction model 548 may utilize one or more processes, algorithms, or other mechanisms for selecting exploratory set features 556 from the one or more exploratory feature sets 545a-545n for inclusion in the dynamic framework feature set 532. For example, the feature extraction model may select one or more entire exploratory feature sets 545a-545n, such as, the n (where n is a number) exploratory feature sets 545a-545n having the highest normalized exploratory feature set score. The feature extraction model 548 may randomly select exploratory set features 556 from the n exploratory feature sets 545a-545n having the highest normalized exploratory feature set score. The feature extraction model 548 may select exploratory set features 556 according to a statistical distribution accounting for the normalized exploratory feature set score of each exploratory feature set 545a-545n and/or exploratory set feature 556. In some embodiments, the selection of exploratory set features 556 for inclusion in the dynamic framework feature set 532 may be determined based at least in part on a machine learning model, as further described in relation to FIG. 7.

As further depicted in FIG. 5A, the feature extraction model 548 generates a dynamic framework feature set 532 comprising selected features 558 based on the selection of one or more exploratory set features 556 comprising one or more exploratory feature sets 545a-545n. The selected features 558 include one or more of the exploratory set features 556 included in any of the exploratory feature sets 545a-545n. In some embodiments, the dynamic framework feature set 532 may be compared to previously generated dynamic framework feature sets to evaluate improvements in the generated dynamic framework feature set 532 before distribution to a machine learning model.

Referring now to FIG. 5B, an example flow diagram illustrating an example process 550b for generating a dynamic framework feature set 532 is provided. As depicted in FIG. 5B, a synthetic feature generation model 542 accesses a user experience content dataset 540 comprising one or more target client characteristics 552 and generates an expanded user experience content dataset 543 including a plurality of synthetic target features 554. As depicted in FIG. 5B, a feature set ensemble generation model 544 generates a plurality of exploratory feature sets 545 each comprising one or more exploratory set features 556. The plurality of exploratory feature sets 545 are associated with a normalized exploratory feature set score as determined by an exploratory feature set validation model 546. As depicted in FIG. 5B, exploratory set features 556 are selected by a feature extraction model 548 for inclusion in one or more candidate dynamic framework feature sets 551 based on the normalized exploratory feature set score. At least one of the one or more candidate dynamic framework feature sets 551 are selected via a second validation process as a dynamic framework feature set 532 by a dynamic framework feature set selection model 549.

As depicted in FIG. 5B, the feature extraction model 548 generates one or more candidate dynamic framework feature sets 551 based on the normalized exploratory feature set score for each exploratory feature set 545a-545n and/or exploratory set feature 556. As described herein, the dynamic framework feature set selection model 549 may select at least one of the one or more candidate dynamic framework feature sets 551 as the dynamic framework feature set 532. Generation of a dynamic framework feature set 532 utilizing a plurality of candidate dynamic framework feature sets 551 is described further in relation to FIG. 9B.

Referring now to FIG. 6, an example content generation framework 602 is provided. As depicted in FIG. 6, the example content generation framework 602 includes an autonomous feature selection model 630 according to the various embodiments described herein communicatively connected to a content generation learning model 636. The autonomous feature selection model 630 is configured to generate one or more dynamic framework feature sets 632 for a content generation model 662 and a supervised learning model 664 based at least in part on content generation objectives 612, an initial user experience content dataset 631, and a feedback user experience content dataset 634. As further depicted in FIG. 6, the content generation learning model 636 includes the content generation model 662 configured to generate one or more content data objects 663 based on candidate content data objects 667 generated by the supervised learning model 664. The content generation learning model 636 includes an environment interface 666 configured to generate renderable content data objects 614 based on the one or more content data objects 663 and generate a content generation learning model state 665 and the feedback user experience content dataset 634 based on interaction data signals 616 received from one or more target clients.

As depicted in FIG. 6, the autonomous feature selection model is configured to access or receive an initial user experience content dataset 631 and a feedback user experience content dataset 634. In some embodiments, the initial user experience content dataset 631 provides historical data, including target client characteristics and responsive actions taken by target clients in response to renderable content data objects 614. An initial user experience content dataset 631 may be used to determine a dynamic framework feature set 632 during a machine learning training process based on the content generation objectives 612. In addition, an updated dynamic framework feature set 632 may be periodically generated based on the feedback user experience content dataset 634 and in accordance with the content generation objectives 612. The feedback user experience content dataset 634 may include state data, including target client characteristics and responsive actions taken by target clients in response to transmitted renderable content data objects 614. Periodically providing an updated dynamic framework feature set 632 based on the feedback user experience content dataset 634 may improve the overall accuracy and reliability of a content generation learning model 636 because the updated machine learning models comprising the content generation learning model 636 more accurately reflect updated outcomes based on the target client's responsive actions. In addition, periodically updating the dynamic framework feature set 632 in an autonomous framework may eliminate the need for manual intervention in the feature selection process, reducing errors introduced into the system through human error and reducing the cost to operate a content generation framework 602.

As further depicted in FIG. 6, the content generation learning model 636 includes a content generation model 662 and a supervised learning model 664, each configured to access the dynamic framework feature set 632 and periodically updated dynamic framework feature sets 632. Although both the content generation model 662 and the supervised learning model 664 are depicted as utilizing the dynamic framework feature set 632 in FIG. 6, in some embodiments, an individual dynamic framework feature set 632 may be generated separately, one specifically for the content generation model 662 and another specifically for the supervised learning model 664. In some embodiments, only one of the content generation model 662 or the supervised learning model 664 may utilize the dynamic framework feature set 632. In some embodiments, multiple dynamic framework feature sets 632 may be generated for the content generation model 662 and/or the supervised learning model 664. For example, multiple dynamic framework feature sets may be generated for different supervised learning models which each pass their own candidate content data objects to the content generation model to factor in on that learning model's decisions, which predictions could be part of the dynamic framework feature set.

The content generation model 662 of FIG. 6 is configured to select a content data object 663 from a plurality of candidate content data objects 667 based on one or more content generation objectives 612 and the content generation learning model state 665. A content generation model 662 selects a unique content data object specific for the intent target client. For example, a content generation model 662 may select a content data object 663 based on a likelihood that the content data object 663 maximizes one or more content generation objectives 612 when delivered to the intended target client. A content generation model 662 utilizes one or more machine learning models to predict outcomes, such as responsive actions of the target client, based on the content generation learning model state 665. In some embodiments, a content generation model 662 is configured to utilize a reinforcement learning (RL) model to generate rated content data objects scored and/or ranked based on one or more objectives provided in the content generation objectives 612. The content generation model may implement an RL policy to determine content data object ranks, content data object scores, and/or confidence values for each content data object in the set of candidate content data objects 667. The content generation model 662 may select a content data object 663 based on the content data object ranks, content data object scores, and/or confidence values associated with the candidate content data objects 667.

A goal of a reinforcement learning model (e.g., content generation model 662) may include configuring the RL policy such that the selected content data object 663 presented to the target client maximizes a reward function. For example, a RL policy may interface with the target client in discrete time steps, where at each time t, the RL policy receives a current state sₜ and reward rₜ as contained in the content generation learning model state 665. The RL policy may determine scoring, ranking, and confidence values for the candidate content data objects 667 and select a content data object 663 based on the scoring, ranking, and confidence values, moving the task environment to a new state sₜ₊₁ where a reward rₜ₊₁ associated with a transition is determined based on the responsive actions of the target client. The reward is received at the content generation model 662 in the content generation learning model state 665 and compared with the primary objectives of the content generation objectives 612. The content generation model 662 utilizes a comparison of the reward rₜ₊₁ and the reward rₜ along with the associated states sₜ₊₁ and sₜ, to determine adjustments to the RL policy. By continually updating the RL policy based on the reward, the RL policy may learn a policy that maximizes the content object rank, content data object score, and confidence value associated with a candidate content data object 667 and the associated content generation learning model state 665.

As further depicted in FIG. 6, the supervised learning model 664 is configured to generate one or more candidate content data objects 667 based on the content generation learning model state 665. In some embodiments, the supervised learning model 664 may include a machine learning model configured to receive a data vector comprising features of the content generation learning model state 665 based on the dynamic framework feature set 632 and generate one or more expanded state characteristics. Expanded state characteristics may be any characteristics of the current state of the learning environment related to the target client that may be derived from the content generation learning model state 665. Non-limiting examples of expanded state characteristics may include characteristics related to the status of one or more users associated with the target client with a vendor, for example, for example a vendor operating the content generation framework 602. The status of one or more users associated with the target client may include whether the associated user is a potential customer, new customer, existing customer, or dormant customer. Other expanded state characteristics may include the likelihood of an associated customer to churn or cease interactions with the vendor. The expanded state characteristics may be combined with the content generation learning model state 665 to generate a learning model expanded state.

The machine learning model may comprise a plurality of mathematical and statistical models trained to determine correlations between the dynamic framework feature set 632 comprising features from the input state of the environment (e.g., content generation learning model state 665) and output expanded state characteristics. In some embodiments, the machine learning model may comprise an artificial neural network or other similar data classifier, including, but not limited to, Bayesian networks, genetic algorithms, regression models, clustering models, and/or a random forest model.

The machine learning model may be initially trained by a training engine configured to adjust the parameters and hyperparameters comprising the mathematical and statistical models of the machine learning model to continually improve the accuracy of the machine learning model based on received state data and corresponding actions of the target client. Training the machine learning model based on the dynamic framework feature set 632 may rapidly generate accurate state classification predictions in fewer iterations, improving the overall performance of the content generation framework 602.

During a classification phase of the supervised learning model 310, the machine learning model may access a vector of data representing the current state. The vector of data representing the current state may include a plurality of features based on the dynamic framework feature set 632. The dynamic framework feature set 632 may comprise a list of features programmatically selected to provide accurate expanded state characteristics when used as inputs to the machine learning model. The machine learning model may access the vector of data representing the current state and generate one or more expanded state characteristics based on the content generation learning model state 665.

In some embodiments, the supervised learning model 664 may also include a decision space generation model configured to generate a plurality of candidate content data objects 667 based on the one or more characteristic ranges and/or characteristic step limitations provided in the content generation objectives 612. As described herein, content data objects comprise one or more variable interactive action characteristics. Variable interactive action characteristics refer to one or more characteristics of a content data object that may be adjusted. For example, a variable interactive action characteristic may include a discount percentage, a voucher amount, a re-use limit, or other similar variable characteristic. Various characteristic ranges may be provided to limit the available range of the decision space. The various characteristic ranges and the available ranges of each variable interactive action characteristic define the decision space for a target client.

In some embodiments, the characteristic ranges may be defined directly or indirectly through the content generation objectives 612. A vendor may specify in the content generation objectives 612 a characteristic range for one or more variable interactive action characteristics. For example, a characteristic range of a discount percentage of a particular product may be set between 0% and 40%. In addition, some characteristic ranges may be established based on industry standard, or otherwise provide through code configuration or configuration settings. The characteristic ranges from each of these disparate sources may be extracted and stored for use by the decision space generation model.

Similarly, characteristic step limitations may be specified in content generation objectives 612, based on industry standards, through code configuration, or though other configuration settings.

The decision space generation model is configured to generate candidate content data objects 667 distributed within the decision space associated with a target client and based at least in part on the learning model expanded state associated with the target client. In some embodiments, various content data objects may be generated based on combinations of variable interactive action characteristics within the characteristic range for the particular variable interactive action characteristics. In some embodiments, various packages of content data objects may be generated combining multiple content data object types. For example, in one specific embodiment, some candidate content data objects 667 may include a particular redeemable voucher, such as a credit to a vendor location, while other candidate content data objects 667 include a credit to the vendor location and a credit to a partner vendor. In some embodiments, candidate content data objects 667 may be equally spaced throughout the decision space. In some embodiments, candidate content data objects 667 may be distributed throughout the decision space based using a statistical distribution based on the desired outcomes.

As further depicted in FIG. 6, the content generation learning model 636 includes an environment interface 666 configured to transmit renderable content data objects 614 and receive interaction data signals 616. Although depicted as a single interface in FIG. 6, the environment interface 666 may be configured as a plurality of interfaces, for example a separate environment interface 666 for transmitting renderable content data objects 614 and for received interaction data signals 616. In some embodiments, the environment interface 666 may include hardware and/or software to transmit selected content data objects 663 and associated content to produce a renderable content data object 614. A renderable content data object 614 may include additional data including graphic, notification, communication, or other data necessary to render the content data object on a target client. In some embodiments, the renderable content data object 614 may be equivalent to the content data object 663.

As further depicted in FIG. 6, the environment interface 666 is configured to generate a content generation learning model state 665 based on the interaction data signals 616 received from the target client. The content generation learning model state 665 refers to one or more data constructs representing the current state of the target client for which the renderable content data object 614 has been provided. The content generation learning model state 665 may include updated characteristics of the target client, such as demographic data and/or status data. The content generation learning model state 665 may also include recent and historical responsive actions by the target client in response to received renderable content data objects 614. In addition, the content generation learning model state 665 may include reward data quantifying the outcome of the renderable content data object 614 with respect to one or more objectives identified by the content generation objectives 612. The content generation learning model state 665 may be leveraged to update one or more machine learning models in the content generation learning model 636. For example, the supervised learning model 664, and the content generation model 662, among others.

Content generation learning models are further discussed in U.S. application Ser. No. 18/665,210 filed May 15, 2024, and entitled, “EXPERIMENTAL CONTENT GENERATION LEARNING MODEL FOR RAPID MACHINE LEARNING IN A DATA-CONSTRAINED ENVIRONMENT,” the entirety of which is incorporated by reference herein.

Referring now to FIG. 7, an example content generation framework 702 is provided. As depicted in FIG. 7, the example content generation framework 702 includes an autonomous feature selection model 730 communicatively connected to a content generation learning model 736. The autonomous feature selection model 730 is configured to generate one or more dynamic framework feature sets 732 for a content generation model 762 and a supervised learning model 764. As further depicted in FIG. 7, the content generation learning model 736 includes the content generation model 762 configured to generate one or more content data objects 763 based on candidate content data objects 767 generated by the supervised learning model 764. The content generation learning model 736 may include an environment interface 766 configured to generate renderable content data objects 714 based on the one or more content data objects 763 and generate a content generation learning model state 765 and the feedback user experience content dataset 734 based on interaction data signals 716 received from one or more target clients.

As further depicted in FIG. 7, the example content generation framework 702 includes a feature selection machine learning model 770 configured to generate a machine learning selection output 772 informing the selection of features by the feature extraction model in the autonomous feature selection model 730. As described in relation to FIG. 4, a feature selection model (e.g., feature extraction model 448) may utilize one or more processes, algorithms, or other mechanisms for selecting features for inclusion in the dynamic framework feature set 732 and/or one or more candidate dynamic framework feature sets to determine the dynamic framework feature set 732. In some embodiments, the exploratory set features included in the plurality of exploratory feature sets may be selected based on a machine learning model. In one embodiment, a machine learning model may be trained based on the initial user experience content dataset 731 and one or more content generation objectives 712 to select features from the plurality of exploratory feature sets for inclusion in the dynamic framework feature set 732 and/or one or more candidate dynamic framework feature sets. The machine learning model may inform the number of features to be selected, the number of features to be selected from each exploratory feature set, the relative position of the features within the plurality of exploratory feature sets, and so on. The feature selection machine learning model 770 may be periodically updated based on the feedback user experience content dataset 734 comprising updated target client characteristics and interaction data signals 716. Utilizing the feature selection machine learning model 770 to inform the selection of features in the dynamic framework feature set 732 may improve the accuracy and performance of the content generation framework 702.

Referring now to FIG. 8, an example flow diagram illustrating an example process 880 for generating a dynamic framework feature set 832 is provided. As depicted in FIG. 8, a synthetic feature generation model 842 accesses a user experience content dataset 840 comprising one or more target client characteristics 852 and generates an expanded user experience content dataset 843 including a plurality of synthetic target features 854. As further depicted in FIG. 8, a feature set ensemble generation model 844 generates a plurality of exploratory feature sets 845 each comprising one or more exploratory set features 856. As further depicted in FIG. 8, the exploratory feature set validation model 846 determines a normalized exploratory feature set score for each exploratory feature set 845a-845n. Based on the normalized exploratory feature set score associated with each exploratory feature set 845a-845n, the number of exploratory feature sets 845a-845n are reduced into one or more screened exploratory feature sets 882, comprising screened exploratory feature sets 882a-882n. Screened set features 884 of the one or more screened exploratory feature sets 882 are selected for inclusion in a dynamic framework feature set 832. The process 880 may utilize a feature extraction model 848 and/or a dynamic framework feature set selection model 849 to determine one or more selected features 858. The selected features 858 are selected to comprise the dynamic framework feature set 832.

As depicted in FIG. 8, the screened exploratory feature sets 882 are selected based on the normalized exploratory feature set score associated with each exploratory feature set 845a-845n. A screened exploratory feature set 882a may comprise one or more of the exploratory feature sets 845. An exploratory feature set validation model 846 may use one or more processes, methods, or mechanisms to select the exploratory feature sets 845a-845n to be included in the screened exploratory features sets 882. For example, an exploratory feature set validation model 846 may select the exploratory feature sets 845a-845n associated with the highest normalized exploratory feature set score. In some embodiments, the number of screened exploratory feature sets 882 may be pre-determined. In some embodiments, the number of screened exploratory feature sets 882 may be determined autonomously based on the distribution of normalized exploratory feature set scores.

In the depicted embodiment, generation of the dynamic framework feature set 832 may benefit from a reduction of available feature sets (e.g., screened exploratory feature sets 882). A reduction in prospective feature sets reduces the amount of data analyzed by the feature extraction model, thus leading to performance improvements in the operation of the automated feature extraction model. In addition, a reduction in prospective feature sets may improve the results from a machine learning model trained and classified with the resulting dynamic framework feature set 832 by shrinking the collection of available features and improving the overall quality of the remaining available features.

Referring now to FIG. 9A, an example process 900 for autonomously training a content generation learning model (e.g., content generation learning model 336, 636, 736) using an autonomously-generated dynamic framework feature set (e.g., dynamic framework feature set 332, 432, 532, 632, 732, 832) is provided. At block 902, the content generation framework (e.g., content generation framework 102, 302, 602, 702) receives a user experience content dataset (e.g., user experience content dataset 110, 410; initial user experience content dataset 331, 631, 731; feedback user experience content dataset 334, 634, 734) comprising target client characteristics (e.g., target client characteristics 552, 852) related to a plurality of target clients (e.g., target clients 108a-108n, 308). As described herein, an initial user experience content dataset may be received and/or made accessible to the content generation framework as a training dataset during a machine learning training process. Once deployed, a feedback user experience content dataset may be periodically received and/or made accessible to the content generation framework during a machine learning prediction process. Each user experience content dataset includes data related to the state of the target client and the environment in which the target client operates, including target client characteristics. The content generation framework may utilize the user experience content dataset to set and update parameters throughout the content generation framework.

At block 904, the content generation framework generates, based at least in part on the user experience content dataset, a plurality of exploratory feature sets (e.g., exploratory feature sets 445, 545, 845) each comprising one or more target client characteristics of the user experience content dataset. As described herein, the content generation framework may use one or more feature generation models to generate a plurality of exploratory feature sets given the user experience content dataset. In generating exploratory feature sets, the content generation framework may use any type and any number of feature generation models. A variety of feature generation models may result in varying exploratory feature sets within the plurality of exploratory feature sets. The varying exploratory feature sets may enable the selection of strong and informative features, relative to the content generation objectives. In some embodiments, the content generation framework may generate, based at least in part on a list-based feature generation model, one or more list-based exploratory feature sets for inclusion in the plurality of exploratory feature sets. Similarly, in some embodiments, the content generation framework may generate, based at least in part on a rank-based feature generation model, one or more rank-based exploratory feature sets for inclusion in the plurality of exploratory feature sets, including generating a rank-based feature score for each exploratory set feature in the one or more rank-based exploratory feature sets. In some embodiments, the content generation framework may utilize one or more dimensionality reduction techniques in generating one or more exploratory feature sets of the plurality of exploratory feature sets.

At block 906, the content generation framework generates a normalized exploratory feature set score for each exploratory feature set (e.g., exploratory feature set 545a-545n, exploratory feature set 845a-845n) of the plurality of exploratory feature sets, wherein the normalized exploratory feature set score indicates a relative priority of each exploratory feature set relative to the plurality of exploratory feature sets based at least in part on one or more content generation objectives (e.g., content generation objectives 112, 312, 412, 612, 712). Each of the exploratory feature sets may utilize a different evaluation mechanism to evaluate the performance of the particular exploratory feature set. As described herein, the content generation framework generates a normalized exploratory feature set score for each exploratory feature set. The normalized exploratory feature set score enables a comparison of the exploratory feature sets, even in an instance in which different feature generation models were used to generate the exploratory feature sets. The comparison of exploratory feature sets using the normalized features set scores enables a relative priority to be determined amongst the exploratory feature sets.

At block 908, the content generation framework generates a dynamic framework feature set (e.g., dynamic framework feature set 332, 432, 532, 632, 732, 832) comprising a plurality of selected features (e.g., selected features 558, 858) of the user experience content dataset by selecting one or more exploratory set features (e.g., exploratory set features 556, 856) of the plurality of exploratory feature sets based at least in part on the normalized exploratory feature set scores. As described herein, the content generation framework may utilize one or more processes to select the features comprising the plurality of exploratory feature sets based on the normalized exploratory feature set scores. For example, features may be selected randomly, features may be selected from one or more of the exploratory features sets associated with the highest normalized exploratory feature set scores, features may be selected based on a statistical distribution accounting for the normalized exploratory feature set scores, and so on. The autonomous generation of the dynamic framework feature set based on a user experience content dataset and one or more content generation objectives may enable a content generation framework to produce accurate predictions with little or no manual intervention, thus reducing the cost of operation of the content generation framework and reducing the likelihood of errors in the autonomous content generation system.

Referring now to FIG. 9B, in some embodiments, generating a dynamic framework feature set may comprise one or more of blocks 914a-914c. For example, at block 914a, a content generation framework may generate a plurality of candidate dynamic framework feature sets (e.g., candidate dynamic framework feature sets 551), each candidate dynamic framework feature set comprising at least one selected feature of the plurality of selected features. In some embodiments, the feature extraction model (e.g., feature extraction model 448, 548, 848) may generate a plurality of candidate dynamic framework feature sets based on varied feature selection mechanisms. Each candidate dynamic framework feature set may comprise one or more selected features selected according to one or more processes, algorithms, or other mechanisms for selecting exploratory set features, such as those described in relation to FIGS. 4-5B.

At block 914b, a content generation framework may generate a candidate dynamic framework feature set score for each candidate dynamic framework feature set in the plurality of candidate dynamic framework feature sets. The candidate dynamic framework feature set score may indicate a relative priority of each candidate dynamic framework feature set relative to the plurality of candidate dynamic framework feature sets based at least in part on the one or more content generation objectives.

The various processes, algorithms, or other mechanisms for selecting exploratory set features utilized by a feature extraction model may consider normalized exploratory feature set scores and/or exploratory feature scores in determining the one or more selected features to include in the dynamic framework feature set. In some instances, high exploratory feature scores and/or high normalized exploratory feature set scores may not guarantee a collection of selected features in the dynamic framework feature set exhibit high performance. Thus, the feature extraction model of the content generation framework may generate one or more candidate dynamic framework feature sets based on a collection of selected features from the plurality of exploratory feature sets and determine a candidate dynamic framework feature set score for each candidate dynamic framework feature set to optimize the overall dynamic framework feature set as a set rather than the sum of its individual scores.

A feature extraction model may use any scoring mechanism to generate a candidate dynamic framework feature set score for each candidate dynamic framework feature set. For example, the feature extraction model may generate predicted outcomes using a machine learning model trained with the features included in a candidate dynamic framework feature set based on historical learning model state data for a vendor utilizing the content generation framework. The predicted outcomes may then be compared to the historically observed outcomes. The performance of the machine learning model based on the candidate dynamic framework feature set may be quantified, and a candidate dynamic framework feature set score and/or relative priority may be assigned.

In addition, in some embodiments, the feature extraction model may generate predicted outcomes using a machine learning model trained with the features included in a candidate dynamic framework feature set based on historical data derived from other, similarly situated vendors. For example, data associated with a similar vendor may be used in place of or to augment the historical learning model state data for the vendor utilizing the content generation data. The predicted outcomes may then be compared to the historically observed outcomes for the other vendors. The performance of the machine learning model based on the candidate dynamic framework feature set may be quantified, and a candidate dynamic framework feature set score and/or relative priority may be assigned.

The feature extraction model may be configured to generate a candidate dynamic framework feature set score based on a predicted performance of the candidate dynamic framework feature set using one or more predictive quantification methods. One example prediction quantification method may include withholding a portion of the historical learning model state data during training of the machine learning model. In such an instance, the feature extraction module may generate predicted outcomes using a machine learning model on the withheld data. Thus, predicted outcomes based on the candidate dynamic framework feature set may not be biased by the training data. The predicted outcomes may then be compared to the historically observed outcomes for the withheld data. The performance of the machine learning model based on the candidate dynamic framework feature set may be quantified, and a candidate dynamic framework feature set score and/or relative priority assigned.

Another predictive quantification method may include withholding a most recent portion of the historical learning model state data during training of the machine learning model. In such an instance, the feature extraction model may generate predicted outcomes using a machine learning model on the most recent portion of the historical learning model state data. The predicted outcomes for the most recent portion may then be compared to the historically observed outcomes for the most recent portion of data. The performance of the machine learning model based on the candidate dynamic framework feature set may be quantified, and a candidate dynamic framework feature set score and/or relative priority may be assigned.

Predictive quantification methods may include determining a candidate dynamic framework feature set score based on a statistical model of the performance of a machine learning model trained utilizing a given candidate dynamic framework feature set. For example, a precision-recall curve may be generated to Various quantifications may be derived from a precision-recall curve that may be utilized to measure the success of the machine learning model during future deployment. For example, an area under the precision-recall curve may indicate the success of the machine learning model trained with the selected exploratory feature set. In another example, an F-score or F-value may be determined based on the precision-recall curve. Additional calculations may be determined based on a statistical model of the performance of a machine learning model trained utilizing a given candidate dynamic framework feature set to determine the candidate dynamic framework feature set score.

At block 914c, a content generation framework may assign a candidate dynamic framework feature set from the plurality of candidate dynamic framework feature sets as the dynamic framework feature set based at least in part on the candidate dynamic framework feature set score. For example, the feature extraction model may utilize a dynamic framework feature set selection model (e.g., dynamic framework feature set selection model 449, 549) to select the candidate dynamic framework feature set as the dynamic framework feature set 532. In one embodiment, the dynamic framework feature set selection model may select the candidate dynamic framework feature set receiving the highest candidate dynamic framework feature set score.

Returning to FIG. 9A, at block 910, the content generation framework generates, using a content generation learning model (e.g., content generation learning model 336, 636, 736), a plurality of content data objects (e.g., content data object 663, 763) comprising a unique content data object customized for each of the plurality of target clients, wherein the content generation learning model is trained based at least in part on the dynamic framework feature set. As described herein, the content generation framework may utilize one or more machine learning models (e.g., content generation model 662, 762, supervised learning model 664, 764) to determine content data objects specifically selected to induce responsive actions from one or more target clients and/or users associated with the target clients.

At block 912, the content generation framework transmits a visual representation of the plurality of content data objects to one or more user devices associated with the plurality of target clients. In some embodiments, the content generation framework may generate a visual representation, for example, a renderable content data object (e.g., renderable content data objects 114, 314, 614, 714) to be transmitted, or otherwise made available to a target client and/or a user associated with the target client. The visual representation may include a user interface or graphics to display at a target client. Further, the visual representation may be formatted as a notification, email, text, or other similar electronic communication. The visual representation may invite a user associated with the target client to click a button, open a link, respond to a text or email, purchase a product, or otherwise respond to the electronic communication.

Although an example processing system has been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random-access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

1. An apparatus comprising one or more processors and one or more storage devices storing instructions that are operable, when executed by the one or more processors, to cause the one or more processors to:
generate, using a trained content generation reinforcement learning model and based on a set of features, a content data object customized for a target client;
receive a feedback user experience content dataset comprising client characteristics related to a plurality of clients, and based on interaction data from the target client relative to the content data object;
generate, based at least in part on the feedback user experience content dataset, a plurality of exploratory feature sets each comprising one or more of the client characteristics of the feedback user experience content dataset, wherein each of the plurality of exploratory feature sets is generated based on at least one different feature generation model applied to the feedback user experience content dataset;
generate a normalized exploratory feature set score for each exploratory feature set of the plurality of exploratory feature sets, wherein the normalized exploratory feature set score indicates a relative priority of each exploratory feature set relative to the plurality of exploratory feature sets based at least in part on one or more content generation objectives;
determine a plurality of feature labels of a dynamic framework feature set based at least in part on the normalized exploratory feature set scores;
retrain the trained content generation reinforcement learning model using a training data set generated based on the plurality of feature labels of the dynamic framework feature set to generate a retrained content generation reinforcement learning model;
determine an updated set of features for a new target client based on the client characteristics of the new target client and the plurality of feature labels of the dynamic framework feature set;
generate, using the retrained content generation reinforcement learning model and based on the updated set of features, a unique content data object customized for the new target client; and
transmit a visual representation of the unique content data object to one or more user devices associated with the new target client.

2. The apparatus of claim 1, wherein the plurality of exploratory feature sets comprises one or more list-based exploratory feature sets and one or more rank-based exploratory feature sets, and the one or more storage devices store instructions that are operable, when executed by the one or more processors, to further cause the one or more processors to:
generate, based at least in part on a list-based feature generation model, the one or more list-based exploratory feature sets; and
generate, based at least in part on a rank-based feature generation model, the one or more rank-based exploratory feature sets,
wherein each exploratory set feature in the one or more rank-based exploratory feature sets is associated with a rank-based feature score.

3. The apparatus of claim 2, wherein the list-based feature generation model comprises a genetic feature selection algorithm or a chi-square feature selection algorithm.

4. The apparatus of claim 1, wherein the one or more storage devices store instructions that are operable, when executed by the one or more processors, to further cause the one or more processors to:
generate a plurality of synthetic target features based at least in part on historical client characteristics.

5. The apparatus of claim 1, wherein the dynamic framework feature set comprises an exploratory feature set associated with a highest normalized exploratory feature set score.

6. (canceled)

7. (canceled)

8. The apparatus of claim 1, wherein the one or more storage devices store instructions that are operable, when executed by the one or more processors, to further cause the one or more processors to:
receive an updated feedback user experience content dataset comprising interaction data from the new target client based at least in part on the visual representation of the unique content data object presented to the new target client on the one or more user devices.

9. (canceled)

10. The apparatus of claim 1, wherein the one or more storage devices store instructions that are operable, when executed by the one or more processors, to further cause the one or more processors to:
generate one or more screened exploratory feature sets by selecting a subset of exploratory feature sets of the plurality of exploratory feature sets based at least in part on the normalized exploratory feature set score; and
determine the plurality of feature labels of the dynamic framework feature set by selecting one or more screened set features from the one or more screened exploratory feature sets.

11. The apparatus of claim 1, wherein to determine the plurality of feature labels of the dynamic framework feature set, the one or more storage devices store instructions that are operable, when executed by the one or more processors, to further cause the one or more processors to:
select one or more exploratory set features of the plurality of exploratory feature sets based on a correlation of exploratory set features between a subset of the plurality of exploratory feature sets.

12. The apparatus of claim 1, wherein the one or more storage devices store instructions that are operable, when executed by the one or more processors, to further cause the one or more processors to:
train a feature selection machine learning model based on the feedback user experience content dataset and the one or more content generation objectives; and
determine, using the feature selection machine learning model, one or more feature labels of the dynamic framework feature set from the plurality of exploratory feature sets.

13. The apparatus of claim 1, wherein the one or more storage devices store instructions that are operable, when executed by the one or more processors, to further cause the one or more processors to:
generate a plurality of candidate dynamic framework feature sets, each candidate dynamic framework feature set comprising at least one selected feature from the plurality of exploratory feature sets;
generate a candidate dynamic framework feature set score for each candidate dynamic framework feature set in the plurality of candidate dynamic framework feature sets,
wherein the candidate dynamic framework feature set score indicates a relative priority of each candidate dynamic framework feature set relative to the plurality of candidate dynamic framework feature sets based at least in part on the one or more content generation objectives; and
assign a candidate dynamic framework feature set from the plurality of candidate dynamic framework feature sets as the dynamic framework feature set based at least in part on the candidate dynamic framework feature set score.

14. The apparatus of claim 1, wherein the one or more content generation objectives comprise a first content generation objective and a second content generation objective, and wherein the one or more storage devices store instructions that are operable, when executed by the one or more processors, to further cause the one or more processors to:
generate a first normalized exploratory feature set score for each exploratory feature set of the plurality of exploratory feature sets, wherein the first normalized exploratory feature set score indicates a relative priority of each exploratory feature set relative to the plurality of exploratory feature sets based at least in part on the first content generation objective;
generate a second normalized exploratory feature set score for each exploratory feature set of the plurality of exploratory feature sets, wherein the second normalized exploratory feature set score indicates a relative priority of each exploratory feature set relative to the plurality of exploratory feature sets based at least in part on the second content generation objective;
generate a first dynamic framework feature set comprising a plurality of selected features of the feedback user experience content dataset by selecting one or more exploratory set features of the plurality of exploratory feature sets based at least in part on the first normalized exploratory feature set scores; and
generate a second dynamic framework feature set comprising a plurality of selected features of the feedback user experience content dataset by selecting one or more exploratory set features of the plurality of exploratory feature sets based at least in part on the second normalized exploratory feature set scores.

15. A computer-implemented method, comprising:
generating, using a trained content generation reinforcement learning model and based on a set of features, a content data object customized for a target client;
receiving a feedback user experience content dataset comprising client characteristics related to a plurality of clients, and based on interaction data from the target client relative to the content data object;
generating, based at least in part on the feedback user experience content dataset, a plurality of exploratory feature sets each comprising one or more of the client characteristics of the feedback user experience content dataset, wherein each of the plurality of exploratory feature sets is generated based on at least one different feature generation model applied to the feedback user experience content dataset;
generating a normalized exploratory feature set score for each exploratory feature set of the plurality of exploratory feature sets, wherein the normalized exploratory feature set score indicates a relative priority of each exploratory feature set relative to the plurality of exploratory feature sets based at least in part on one or more content generation objectives;
determining a plurality of feature labels of a dynamic framework feature set based at least in part on the normalized exploratory feature set scores;
retraining the trained content generation reinforcement learning model using a training data set generated based on the plurality of feature labels of the dynamic framework feature set to generate a retrained content generation reinforcement learning model;
determining an updated set of features for a new target client based on the client characteristics of the new target client and the plurality of feature labels of the dynamic framework feature set;
generating, using the retrained content generation reinforcement learning model and based on the updated set of features, a unique content data object customized for the new target client; and
transmitting a visual representation of the unique content data object to one or more user devices associated with the new target client.

16. The computer-implemented method of claim 15, wherein the plurality of exploratory feature sets comprises one or more list-based exploratory feature sets and one or more rank-based exploratory feature sets, the computer-implemented method further comprising:
generating, based at least in part on a list-based feature generation model, the one or more list-based exploratory feature sets; and
generating, based at least in part on a rank-based feature generation model, the one or more rank-based exploratory feature sets,
wherein each exploratory set feature in the one or more rank-based exploratory feature sets is associated with a rank-based feature score.

17. The computer-implemented method of claim 15, further comprising:
generating a plurality of synthetic target features based at least in part on historical client characteristics.

18. (canceled)

19. (canceled)

20. The computer-implemented method of claim 15, further comprising:
receiving an updated feedback user experience content dataset comprising interaction data from the new target client based at least in part on the visual representation of the unique content data object presented to the new target client on the one or more user devices;
determining an updated dynamic framework feature set based at least in part on the updated feedback user experience content dataset; and
retraining the trained content generation reinforcement learning model based at least in part on the updated dynamic framework feature set.

21. A computer program product for determining a dynamic framework feature set for a learning framework, the computer program product comprising at least one non-transitory computer-readable storage medium having computer-readable program code portions stored therein, the computer-readable program code portions comprising an executable portion configured to:
generate, using a trained content generation reinforcement learning model and based on a set of features, a content data object customized for a target client;
receive a feedback user experience content dataset comprising client characteristics related to a plurality of clients, and based on interaction data from the target client relative to the content data object;
generate, based at least in part on the feedback user experience content dataset, a plurality of exploratory feature sets each comprising one or more of the client characteristics of the feedback user experience content dataset, wherein each of the plurality of exploratory feature sets is generated based on at least one different feature generation model applied to the feedback user experience content dataset;
generate a normalized exploratory feature set score for each exploratory feature set of the plurality of exploratory feature sets, wherein the normalized exploratory feature set score indicates a relative priority of each exploratory feature set relative to the plurality of exploratory feature sets based at least in part on one or more content generation objectives;
determine a plurality of feature labels of a dynamic framework feature set based at least in part on the normalized exploratory feature set scores;
retrain the trained content generation reinforcement learning model using a training data set generated based on the plurality of feature labels of the dynamic framework feature set to generate a retrained content generation reinforcement learning model;
determine an updated set of features for a new target client based on the client characteristics of the new target client and the plurality of feature labels of the dynamic framework feature set;
generate, using the retrained content generation reinforcement learning model and based on the updated set of features, a unique content data object customized for the new target client; and
transmit a visual representation of the unique content data object to one or more user devices associated with the new target client.

22. The computer program product of claim 21, wherein the plurality of exploratory feature sets comprises one or more list-based exploratory feature sets and one or more rank-based exploratory feature sets, the executable portion of the computer program product is further configured to:
generate, based at least in part on a list-based feature generation model, the one or more list-based exploratory feature sets; and
generate, based at least in part on a rank-based feature generation model, the one or more rank-based exploratory feature sets,
wherein each exploratory set feature in the one or more rank-based exploratory feature sets is associated with a rank-based feature score.
